(19) United States
(12) Patent Application Publication
(10) Pub. No.: US 2023/0300652 A1
(43) Pub. Date: Sep. 21, 2023

(54) CHANNEL STATE INFORMATION REPORT BASED ON REFERENCE SIGNAL AND HYPOTHESIS IN FULL DUPLEX

(71) Applicant: QUALCOMM Incorporated, San Diego, CA (US)

(72) Inventors: Min Huang, Beijing (CN); Chao Wei, Beijing (CN); Hao Xu, Beijing (CN)

(21) Appl. No.: 17/997,612

(22) PCT Filed: Jun. 11, 2021
(86) PCT No.: PCT/CN2021/099647

§ 371 Date: Oct. 31, 2022

(30) Foreign Application Priority Data
Jun. 12, 2020 (WO) PCT/CN2020/095869

(51) Int. Cl. H04W 24/10; H04W 24/08; H04B 7/06

(52) U.S. Cl. CPC H04W 24/10; H04W 24/08; H04B 7/0626

(57) ABSTRACT

Aspects of the disclosure relate to a wireless user equipment (UE) configured to receive a downlink in a network configured for full duplex communication. The UE receives from the network an indication of one or more candidate two-dimensional hypotheses for channel state information (CSI) reporting. The UE measures interference of a signal from the aggressor UE, and based on the measurement, determines one or more preferred two-dimensional hypotheses, from the candidate two-dimensional hypotheses. The UE may further determine one or more downlink transmission parameters for a downlink the UE receives, corresponding to the preferred two-dimensional hypotheses. The UE then transmits a CSI report that includes an indication of preferred two-dimensional hypotheses. The CSI report may further include the determined downlink transmission parameters. Other aspects, embodiments, and features are also claimed and described.

### PRIORITY CLAIM

This application claims priority to and the benefit of PCT Application No. PCT/CN2020/095869 filed in the China National Intellectual Property Administration on Jun. 12, 2020, the entire content of which is incorporated herein by reference as if fully set forth below in its entirety and for all applicable purposes.

### TECHNICAL FIELD

The technology discussed below relates generally to wireless communication systems, and more particularly, to interference handling in a wireless communication system configured for full duplex.

### INTRODUCTION

In wireless communication systems, continuous and systematic improvements have dramatically increased a wireless link's capacity in the same wireless resources. For example, the combined data throughput for uplink (from a mobile device to a base station) and downlink (from a base station to a mobile device) communications over a wireless link is much higher than the past. However, research and development efforts continue to seek ways to further increase a wireless link's capacity.

For example, emerging wireless communication systems such as fifth-generation (5G) networks (including the New Radio (NR) specifications promulgated by 3GPP) have shown interest in the use of full duplex communication, where both endpoints of a wireless link can simultaneously communicate with one other using the same radio resources. Compared to time division duplex (TDD) and frequency division duplex (FDD) schemes, where any given wireless resource is generally dedicated for communication in only one direction, a full duplex feature can potentially double a wireless link's capacity.

As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Although a full duplex feature can potentially double a wireless link's capacity, full realization of the potential of full duplex is complicated by interference. For example, an endpoint receiving a transmission over a full duplex link may suffer from self-interference caused by its own transmission to another endpoint over the same resources. Furthermore, an endpoint receiving a transmission over a full duplex link may suffer from co-channel interference caused by other endpoints transmitting their own signals over the same resources.

Physical isolation of transmission and reception antennas can help reduce such interference. And further, interference cancellation techniques have shown substantial improvements. Still, substantial interest is directed to improving interference handling for full duplex wireless communications.

Various aspects of the disclosure relate to interference handling in a wireless communication network configured for full duplex. In particular, aspects of the disclosure relate to co-channel interference, also referred to as inter-user equipment (inter-UE) interference. A UE (victim UE) receiving a downlink in a full duplex network suffers from inter-UE interference from an aggressor UE transmitting an uplink over the same resources. The victim UE may receive from the network an indication of a set of candidate two-dimensional hypotheses for channel state information (CSI) reporting. The victim UE may then measure one or more reference signals transmitted by the aggressor UE. Based on this measurement the victim UE may determine one or more preferred two-dimensional hypotheses, from the set of candidate two-dimensional hypotheses. The victim UE may further determine one or more downlink transmission parameters for a downlink transmission the victim UE receives, corresponding to respective ones of the preferred two-dimensional hypotheses. The victim UE then transmits a CSI report that includes an indication of the preferred two-dimensional hypotheses, and may further include the determined downlink transmission parameters. Accordingly, a base station can jointly determine a transport format for the aggressor UE's uplink, and a transport format for the victim UE's downlink, in a way that can increase or maximize a combined downlink+uplink throughput for the victim and aggressor UEs.

In one example, a user equipment (UE) configured for wireless communication is disclosed. The UE includes a processor; a transceiver communicatively coupled to the processor; and a memory communicatively coupled to the processor. The processor and the memory are configured to receive, via the transceiver, a channel state information (CSI) report configuration information message including an indication of a set of one or more candidate two-dimensional hypotheses, each candidate two-dimensional hypothesis corresponding to a DL parameter for a DL transmission to the UE and an UL parameter for an UL transmission from a second UE. The processor and the memory are further configured to measure a signal received from the second UE, and to determine one or more two-dimensional hypotheses from the set of candidate two-dimensional hypotheses, based on the measurement of the signal. The processor and the memory are further configured to transmit, via the transceiver, a CSI report including an indication of the determined one or more preferred two-dimensional hypotheses.

In another example, a scheduling entity configured for wireless communication. The scheduling entity includes a processor; a transceiver communicatively coupled to the processor; and a memory communicatively coupled to the processor. The processor and the memory are configured to transmit, via the transceiver, a channel state information (CSI) report configuration message to a first user equipment (UE), including an indication of one or more candidate two-dimensional hypotheses, each corresponding to a DL parameter for a DL transmission to the first UE and an UL parameter for an UL transmission from a second UE. The processor and the memory are further configured to receive, via the transceiver, a CSI report from the first UE, including an indication of at least one two-dimensional hypothesis from the one or more candidate two-dimensional hypotheses. The processor and the memory are also configured to transmit, based on the at least one two-dimensional hypothesis, an uplink resource assignment for the second UE and a DL parameter for a downlink transmission to the first UE.

In one example, a user equipment (UE) configured for wireless communication is disclosed. The UE includes means for receiving a channel state information (CSI) report configuration information message comprising an indication of a set of one or more candidate two-dimensional hypotheses, each candidate two-dimensional hypotheses corresponding to a DL parameter for a DL transmission to the UE and an UL parameter for an UL transmission from a second UE. The UE further includes means for measuring a signal received from the second UE. The UE also includes means for determining one or more two-dimensional hypotheses from the set of one or more candidate two-dimensional hypotheses, based on the measurement of the signal. The UE further includes means for transmitting a CSI report comprising an indication of the determined one or more two-dimensional hypotheses.

In one example, a method of wireless communication at a user equipment (UE) is disclosed. The method includes receiving a channel state information (CSI) report configuration information message comprising an indication of a set of one or more candidate two-dimensional hypotheses, each candidate two-dimensional hypotheses corresponding to a DL parameter for a DL transmission to the UE and an UL parameter for an UL transmission from a second UE. The method further includes measuring a signal received from the second UE, and determining one or more two-dimensional hypotheses from the set of one or more candidate two-dimensional hypotheses, based on the measurement of the signal. The method also includes transmitting a CSI report comprising an indication of the determined one or more two-dimensional hypotheses.

These and other aspects of the technology discussed herein will become more fully understood upon a review of the detailed description, which follows. Other aspects, features, and embodiments will become apparent to those of ordinary skill in the art upon reviewing the following description of specific, exemplary embodiments in conjunction with the accompanying figures. While the following description may discuss various advantages and features relative to certain embodiments and figures, all embodiments can include one or more of the advantageous features discussed herein. In other words, while this description may discuss one or more embodiments as having certain advantageous features, one or more of such features may also be used in accordance with the various embodiments discussed herein. In similar fashion, while this description may discuss exemplary embodiments as device, system, or method embodiments, it should be understood that such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a block diagram illustrating a wireless communication system supporting multiple-input multiple-output (MIMO) communication.

FIG. 4 is a schematic illustration of an organization of wireless resources in an air interface utilizing orthogonal frequency divisional multiplexing (OFDM) according to some embodiments.

FIG. 5 is a conceptual illustration of an example of a base station configured for full duplex, communicating in a downlink with a first device and in an uplink with a second device, utilizing the same wireless resources.

FIGS. 6A-6B provide a conceptual illustration of operation of an integrated access and backhaul (IAB) relay node in a network configured for full duplex.

FIG. 7 is a block diagram conceptually illustrating an example of a hardware implementation for a scheduling entity according to some aspects of the disclosure.

FIG. 8 is a block diagram conceptually illustrating an example of a hardware implementation for a scheduled entity according to some aspects of the disclosure.

FIG. 9 is a flow chart illustrating an exemplary process for interference handling in a wireless communication network configured for full duplex, according to some aspects of the disclosure.

FIG. 10 is another flow chart illustrating an exemplary process for backhaul downlink interference handling in a wireless communication network configured for full duplex, according to some aspects of the disclosure.

FIG. 11 is another flow chart illustrating an exemplary process for backhaul uplink interference handling in a wireless communication network configured for full duplex, according to some aspects of the disclosure.

FIG. 12 is another flow chart illustrating an exemplary process for interference handling with a user equipment (UE) in a wireless communication network configured for full duplex, according to some aspects of the disclosure.

FIG. 13 is another flow chart illustrating an exemplary process for interference handling with a base station in a wireless communication network configured for full duplex, according to some aspects of the disclosure.

FIG. 14 is another flow chart illustrating an exemplary process for backhaul downlink interference handling with a victim node in a wireless communication network configured for full duplex, according to some aspects of the disclosure.

FIG. 15 is another flow chart illustrating an exemplary process for backhaul downlink interference handling with a relay node in a wireless communication network configured for full duplex, according to some aspects of the disclosure.

FIG. 16 is another flow chart illustrating an exemplary process for backhaul uplink interference handling with a parent node in a wireless communication network configured for full duplex, according to some aspects of the disclosure.

FIG. 17 is another flow chart illustrating an exemplary process for backhaul uplink interference handling with a relay node in a wireless communication network configured for full duplex, according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

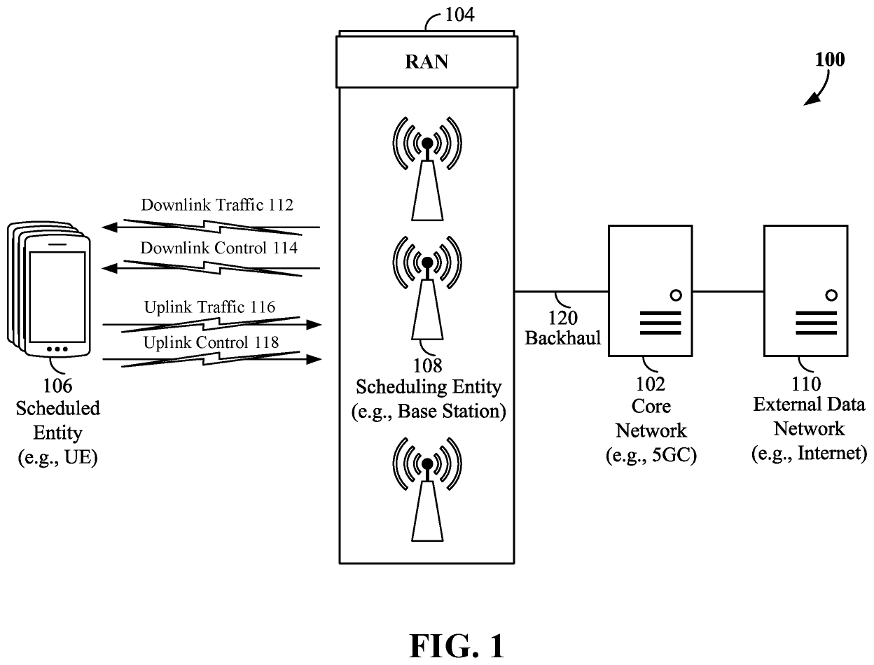

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G or 5G NR. In some examples, the RAN 104 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, those skilled in the art may variously refer to a “base station” as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The RAN 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

Some base stations 108 may be configured as integrated access and backhaul (IAB) nodes, where the wireless spectrum may be used both for access links (i.e., wireless links with UEs 106), and for backhaul links (e.g., links between base stations 108 and/or links to one or more core network nodes). This scheme is sometimes referred to as wireless self-backhauling. By using wireless self-backhauling, rather than requiring each new base station 108 deployment to be outfitted with its own hard-wired backhaul connection, the wireless spectrum utilized for communication between the base station 108 and UE 106 may be leveraged for backhaul communication, enabling fast and easy deployment of highly dense small cell networks. As described further below, some examples of IAB nodes may operate as base stations 108, and some examples of IAB nodes may operate as relay nodes extending the range of a cell. Further, some examples of IAB nodes may be configured for full-duplex, communicating over the same time-frequency resources for both transmitting and receiving wireless signals.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

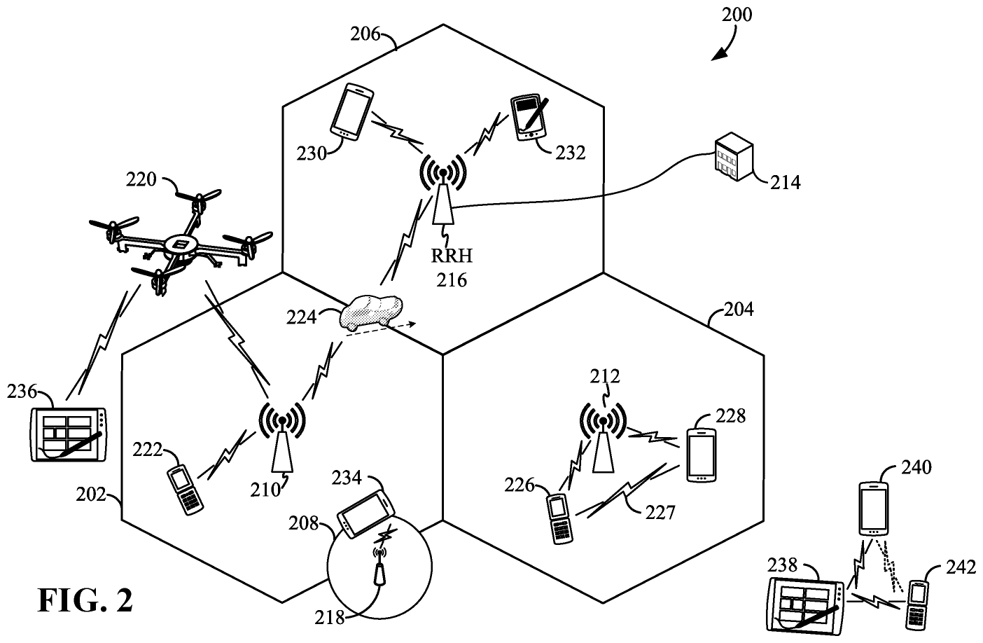

FIG. 2 provides a schematic illustration of a RAN 200, by way of example and without limitation. In some examples, the RAN 200 may be the same as the RAN 104 described above and illustrated in FIG. 1. The geographic area covered by the RAN 200 may be divided into cellular regions (cells) that a user equipment (UE) can uniquely identify based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

FIG. 2 shows two base stations 210 and 212 in cells 202 and 204; and shows a third base station 214 controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

The RAN 200 may include any number of wireless base stations and cells. Further, a RAN may include a relay node to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In the radio access network 200, the ability for a UE to communicate while moving, independent of its location, is referred to as mobility. An access and mobility management function (AMF, not illustrated, part of the core network 102 in FIG. 1) may generally set up, maintain, and release the various physical channels between the UE and the radio access network. The AMF may further include a security context management function (S CMF) that manages the security context for both the control plane and the user plane functionality, and a security anchor function (SEAF) that performs authentication.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

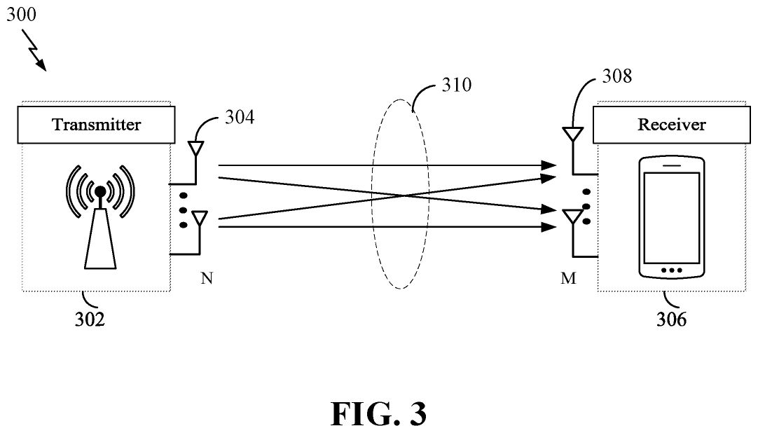

In some aspects of the disclosure, the scheduling entity and/or scheduled entity may be configured with multiple antennas for beamforming and/or multiple-input multiple-output (MIMO) technology. FIG. 3 illustrates an example of a wireless communication system 300 with multiple antennas, supporting beamforming and/or MIMO. The use of such multiple antenna technology enables the wireless communication system to exploit the spatial domain to support spatial multiplexing, beamforming, and transmit diversity.

Beamforming generally refers to directional signal transmission or reception. For a beamformed transmission, a transmitting device may precode, or control the amplitude and phase of each antenna in an array of antennas to create a desired (e.g., directional) pattern of constructive and destructive interference in the wavefront. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

In a MIMO system, spatial multiplexing may be used to transmit multiple different streams of data, also referred to as layers, simultaneously on the same time-frequency resource. In some examples, a transmitter 302 may send multiple data streams to a single receiver. In this way, a MIMO system takes advantage of capacity gains and/or increased data rates associated with using multiple antennas in rich scattering environments where channel variations can be tracked. Here, the receiver 306 may track these channel variations and provide corresponding feedback to the transmitter 302. In one example case, as shown in FIG. 3, a rank-2 (i.e., including 2 data streams) spatial multiplexing transmission on a 2×2 MIMO antenna configuration will transmit two data streams via two transmit antennas 304. The signal from each transmit antenna 304 reaches each receive antenna 308 along a different signal path 310. The receiver 306 may then reconstruct the data streams using the received signals from each receive antenna 308.

In some examples, a transmitter may send multiple data streams to multiple receivers. This is generally referred to as multi-user MIMO (MU-MIMO). In this way, a MU-MIMO system exploits multipath signal propagation to increase the overall network capacity by increasing throughput and spectral efficiency, and reducing the required transmission energy. This is achieved by a transmitter 302 spatially precoding (i.e., multiplying the data streams with different weighting and phase shifting) each data stream (in some examples, based on known channel state information) and then transmitting each spatially precoded stream through multiple transmit antennas to the receiving devices using the same allocated time-frequency resources. A receiver (e.g., receiver 306) may transmit feedback including a quantized version of the channel so that the transmitter 302 can schedule the receivers with good channel separation. The spatially precoded data streams arrive at the receivers with different spatial signatures, which enables the receiver(s) (in some examples, in combination with known channel state information) to separate these streams from one another and recover the data streams destined for that receiver. In the other direction, multiple transmitters can each transmit a spatially precoded data stream to a single receiver, which enables the receiver to identify the source of each spatially precoded data stream.

The number of data streams or layers in a MIMO or MU-MIMO (generally referred to as MIMO) system corresponds to the rank of the transmission. In general, the rank of a MIMO system is limited by the number of transmit or receive antennas 304 or 308, whichever is lower. In addition, the channel conditions at the receiver 306, as well as other considerations, such as the available resources at the transmitter 302, may also affect the transmission rank. For example, a base station in a RAN (e.g., transmitter 302) may assign a rank (and therefore, a number of data streams) for a DL transmission to a particular UE (e.g., receiver 306) based on a rank indicator (RI) the UE transmits to the base station. The UE may determine this RI based on the antenna configuration (e.g., the number of transmit and receive antennas) and a measured signal-to-interference-and-noise ratio (SINR) on each of the receive antennas. The RI may indicate, for example, the number of layers that the UE may support under the current channel conditions. The base station may use the RI along with resource information (e.g., the available resources and amount of data to be scheduled for the UE) to assign a DL transmission rank to the UE.

The transmitter 302 determines the precoding of the transmitted data stream or streams based, e.g., on known channel state information of the channel on which the transmitter 302 transmits the data stream(s). For example, the transmitter 302 may transmit one or more suitable reference signals (e.g., a channel state information reference signal, or CSI-RS) that the receiver 306 may measure. The receiver 306 may then report measured channel quality information (CQI) back to the transmitter 302. This CQI generally reports the current communication channel quality, and in some examples, a requested transport block size (TBS) for future transmissions to the receiver. In some examples, the receiver 306 may further report a precoding matrix indicator (PMI) to the transmitter 302. This PMI generally reports the receiver's 306 preferred precoding matrix for the transmitter 302 to use, and may be indexed to a predefined codebook. The transmitter 302 may then utilize this CQI/PMI to determine a suitable precoding matrix for transmissions to the receiver 306.

In Time Division Duplex (TDD) systems, the UL and DL may be reciprocal, in that each uses different time slots of the same frequency bandwidth. Therefore, in TDD systems, a transmitter 302 may assign a rank for DL MIMO transmissions based on an UL SINR measurement (e.g., based on a sounding reference signal (SRS) or other pilot signal transmitted from the receiver 306). Based on the assigned rank, the transmitter 302 may then transmit a channel state information reference signal (CSI-RS) with separate sequences for each layer to provide for multi-layer channel estimation. From the CSI-RS, the receiver 306 may measure the channel quality across layers and resource blocks. The receiver 306 may then transmit a CSI report (including, e.g., CQI, RI, and PMI) to the transmitter 302 for use in updating the rank and assigning resources for future DL transmissions.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes. For example, a UE may provide for UL multiple access utilizing time division multiple access (TDMA), code division multiple access (CDMA), frequency division multiple access (FDMA), sparse code multiple access (SCMA), resource spread multiple access (RSMA), or other suitable multiple access schemes. Further, a base station may multiplex DL transmissions to UEs utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

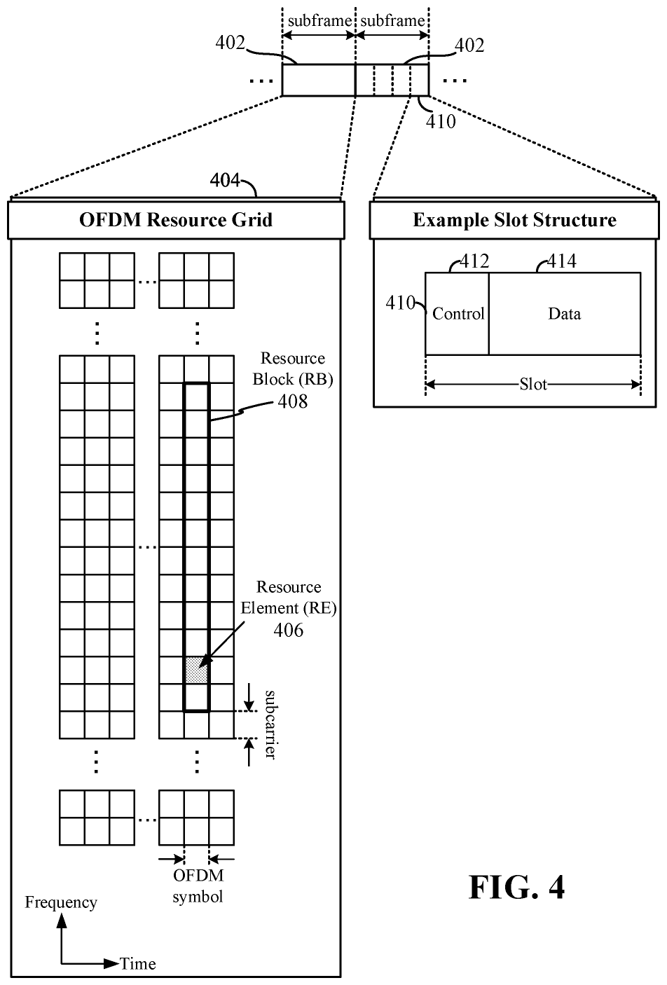

FIG. 4 schematically illustrates various aspects of the present disclosure with reference to an OFDM waveform. Those of ordinary skill in the art should understand that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may consist of a set of subframes (e.g., 10 subframes of 1 ms each). A given carrier may include one set of frames in the UL, and another set of frames in the DL. FIG. 4 illustrates an expanded view of an exemplary DL subframe 402, showing an OFDM resource grid 404. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 404 may schematically represent time-frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and may contain a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. The present disclosure assumes, by way of example, that a single RB such as the RB 408 entirely corresponds to a single direction of communication (either transmission or reception for a given device).

A UE generally utilizes only a subset of the resource grid 404. An RB may be the smallest unit of resources that a scheduler can allocate to a UE. Thus, the more RBs scheduled for a UE, and the higher the modulation scheme chosen for the air interface, the higher the data rate for the UE.

In this illustration, the RB 408 occupies less than the entire bandwidth of the subframe 402, with some subcarriers illustrated above and below the RB 408. In a given implementation, the subframe 402 may have a bandwidth corresponding to any number of one or more RBs 408. Further, the RB 408 is shown occupying less than the entire duration of the subframe 402, although this is merely one possible example.

Each 1 ms subframe 402 may consist of one or multiple adjacent slots. In FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one or two OFDM symbols). A base station may in some cases transmit these mini-slots occupying resources scheduled for ongoing slot transmissions for the same or for different UEs.

An expanded view of one of the slots 410 illustrates the slot 410 including a control region 412 and a data region 414. In general, the control region 412 may carry control channels (e.g., PDCCH), and the data region 414 may carry data channels (e.g., PDSCH or PUSCH). Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within an RB 408 may carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In a DL transmission, the transmitting device (e.g., the scheduling entity 108) may allocate one or more REs 406 (e.g., within a control region 412) to carry one or more DL control channels. These DL control channels include DL control information 114 (DCI) that generally carries information originating from higher layers, such as a physical broadcast channel (PBCH), a physical downlink control channel (PDCCH), etc., to one or more scheduled entities 106. In addition, the transmitting device may allocate one or more DL REs to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

A base station may transmit the synchronization signals PSS and SSS (collectively referred to as SS), and in some examples, the PBCH, in an SS block that includes 4 consecutive OFDM symbols, numbered via a time index in increasing order from 0 to 3. In the frequency domain, the SS block may extend over 240 contiguous subcarriers, with the subcarriers being numbered via a frequency index in increasing order from 0 to 239. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity 106) may utilize one or more REs 406 to carry one or more UL control channels, such as a physical uplink control channel (PUCCH), a physical random access channel (PRACH), etc. These UL control channels include UL control information 118 (UCI) that generally carries information originating from higher layers. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the scheduling entity 108 to schedule uplink transmissions. Here, in response to the SR transmitted on the control channel 118, the scheduling entity 108 may transmit downlink control information 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein a receiving device can check the integrity of packet transmissions for accuracy, e.g., utilizing any suitable integrity checking mechanism, such as a checksum or a cyclic redundancy check (CRC). If the receiving device confirms the integrity of the transmission, it may transmit an ACK, whereas if not confirmed, it may transmit a NACK. In response to a NACK, the transmitting device may send a HARQ retransmission, which may implement chase combining, incremental redundancy, etc.

In addition to control information, one or more REs 406 (e.g., within the data region 414) may be allocated for user data or traffic data. Such traffic may be carried on one or more traffic channels, such as, for a DL transmission, a physical downlink shared channel (PDSCH); or for an UL transmission, a physical uplink shared channel (PUSCH).

In order for a UE to gain initial access to a cell, the RAN may provide system information (SI) characterizing the cell. The RAN may provide this system information utilizing minimum system information (MSI), and other system information (OSI). The RAN may periodically broadcast the MSI over the cell to provide the most basic information a UE requires for initial cell access, and for enabling a UE to acquire any OSI that the RAN may broadcast periodically or send on-demand. In some examples, a network may provide MSI over two different downlink channels. For example, the PBCH may carry a master information block (MIB), and the PDSCH may carry a system information block type 1 (SIB1). Here, the MIB may provide a UE with parameters for monitoring a control resource set. The control resource set may thereby provide the UE with scheduling information corresponding to the PDSCH, e.g., a resource location of SIB1. In the art, SIB1 may be referred to as remaining minimum system information (RMSI).

OSI may include any SI that is not broadcast in the MSI. In some examples, the PDSCH may carry a plurality of SIBs, not limited to SIB1, discussed above. Here, the RAN may provide the OSI in these SIBs, e.g., SIB2 and above.

The channels or carriers described above and illustrated in FIGS. 1 and 4 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

In some examples, a physical layer may generally multiplex and map these physical channels described above to transport channels for handling at a medium access control (MAC) layer entity. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The air interface in the radio access network 200 may utilize one or more duplexing algorithms. Duplex refers to a point-to-point communication link where both endpoints can communicate with one another in both directions. Full duplex means both endpoints can simultaneously communicate with one another using the same radio resources. Half duplex means only one endpoint can send information to the other at a time. In a wireless link, a full duplex carrier generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given carrier are separated from one another using time division multiplexing. That is, at some times the carrier is dedicated for transmissions in one direction, while at other times the carrier is dedicated for transmissions in the other direction, where the direction may change very rapidly, e.g., several times per slot.

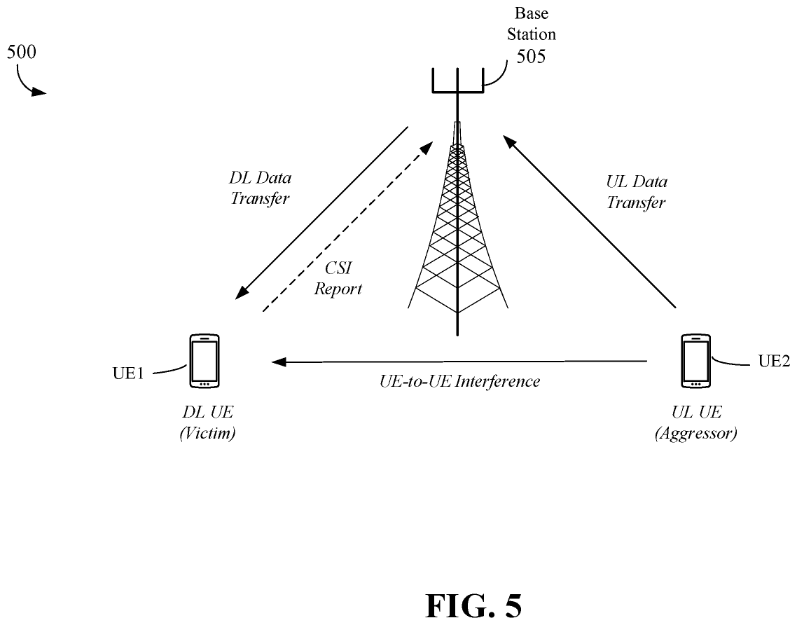

In theory, by reusing resources for both UL and DL communication, full duplex communication techniques can double a link's capacity in comparison to half duplex communication techniques. For example, a full duplex network node, such as a base station in a cellular network, can simultaneously communicate in uplink (UL) and downlink (DL) directions with two half duplex terminals using the same radio resources. FIG. 5 illustrates a communication system 500 including an example of a full duplex enabled base station 505 communicating with two UEs labeled UE1 and UE2. As illustrated, the base station transfers DL data to UE1 at the same time, and over the same resources, as UE2 transfers UL data to the base station. When using this scheme, the UE that transmits the UL signal (UE2) generates inter-UE interference for the UE that receives the DL signal (UE1). And further, the base station generates self-interference, as its DL transmission interferes with its own reception of the UL transmission from UE2.

In another example, a full duplex relay node such as an integrated access and backhaul (IAB) node can act as a relay, extending the range of a cell. That is, by using a relay node, an IAB donor (which can be a base station, e.g., a gNB, or may be another IAB relay node) can transmit data to a UE over an extended range, being relayed by the relay node. And further, an IAB donor can receive data from a UE over an extended range, being relayed by the relay node.

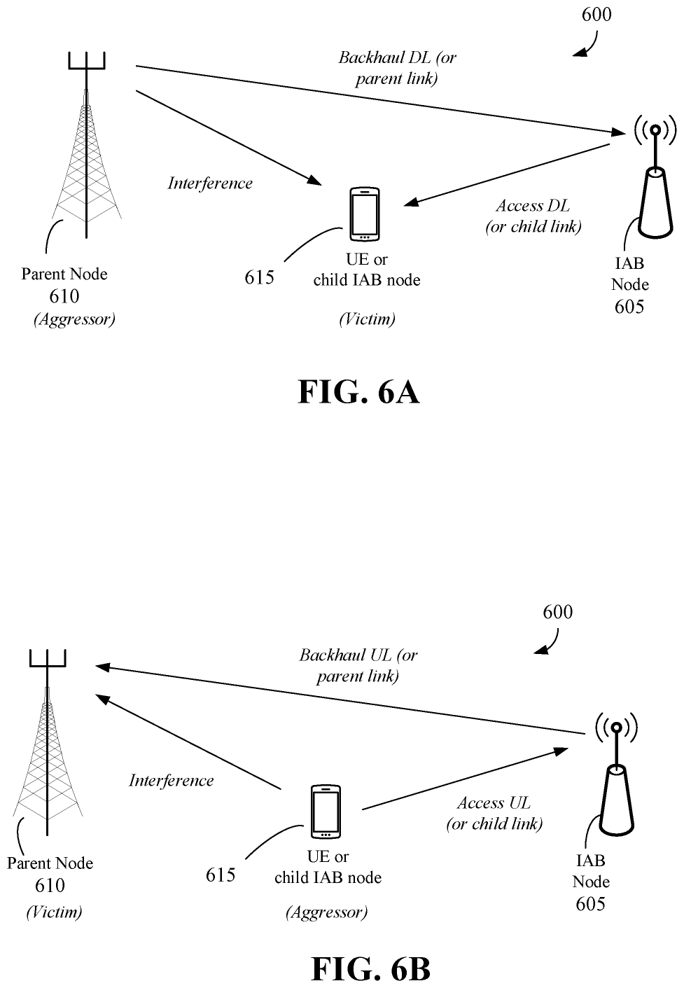

FIGS. 6A and 6B illustrate one such system 600 including at least one full duplex IAB relay node 605. FIG. 6A illustrates signaling in DL communication, and FIG. 6B illustrates signaling in UL communication. In FIGS. 6A and 6B, a parent node (or IAB donor) 610 is a full duplex node, which may correspond either to a base station (e.g., a gNB) or an IAB relay node. Additionally, the IAB node 605 is a full duplex IAB relay node in communication with a UE or child node 615. In a one-hop scenario, the full duplex IAB node (e.g., node 605) simultaneously communicates with an anchor node (e.g., the parent node 610 as a base station) over its backhaul link, and with a UE 615 over its access link. And, in a multi-hop scenario, the full duplex IAB node (e.g., node 605) simultaneously communicates with a parent node (e.g., the parent node 610 as a base station or another IAB relay node) over its backhaul link, and with a child node 615 (e.g., a UE or another IAB relay node) over its access link.

Similar to the example in FIG. 5, in the example of FIG. 6A, interference from the IAB node's backhaul link or parent link (i.e., a DL transmission from the parent node to the IAB node) causes data reception performance deterioration at the UE 615 receiving the IAB node's access link or child link (i.e., a DL transmission from the IAB node to the UE). And, in FIG. 6B, interference from the IAB node's access link or child link (i.e., an UL transmission from the UE to the IAB node) causes data reception performance deterioration at the parent node 610 receiving the IAB node's backhaul link or parent link (i.e., an UL transmission from the IAB node to the parent node).

In the description that follows, in relation to a discussion of inter-UE interference, it is to be understood that reference to a DL UE refers generally to a node, be it a UE or an IAB node, receiving a DL transmission. For example, in relation to FIG. 5, reference to a DL UE may refer to UE1, receiving a DL transmission directly from a base station. In relation to FIG. 6A, reference to a DL UE may refer equivalently to a UE or a child IAB node 615, receiving a DL transmission from an IAB node over the IAB node's access link. Furthermore, in relation to FIG. 5, reference to an UL UE may refer to UE2, transmitting a UL transmission directly to a base station. In relation to FIG. 6B, reference to an UL UE may refer equivalently to a UE transmitting an UL transmission directly to a base station (e.g., parent node 610) or IAB node 605, and to a parent IAB node transmitting an UL transmission from a child IAB node 615 to a base station or other parent node 610 over the IAB backhaul link.

Reference to the respective UEs (including IAB nodes as described in the previous paragraph) as a DL UE and an UL UE is used in the present disclosure to simplify discussion of the inter-UE interference caused by the UL UE upon the DL UE in a full duplex system. Further, when discussing such inter-UE interference in this disclosure, an UL UE may equivalently be referred to as an aggressor UE (or aggressor communication device), and a DL UE may equivalently be referred to as a victim UE (or victim communication device). In other words, reference to a DL UE includes a UE receiving a DL transmission from a base station; a UE receiving a DL transmission over an access link from an IAB relay node; an IAB relay node receiving a DL transmission from a base station over the IAB relay node's backhaul link; and a child IAB node receiving a DL transmission from a parent IAB node over the child IAB node's parent link. And reference to an UL UE includes a UE transmitting an UL transmission to a base station; a UE transmitting an UL transmission over an access link to an IAB relay node; a child IAB node transmitting an UL transmission over a child link to a parent IAB node; and a parent IAB node transmitting an UL transmission over a backhaul link to an IAB donor. Additionally, in FIG. 6A, the parent node 610 may be referred to as an aggressor communication device. In FIG. 6B, the parent node 610 may be referred to as a victim communication device.

In the present disclosure, one or both of the DL UE and/or the UL UE may be configured for half duplex or full duplex. Accordingly, a DL UE may be simultaneously transmitting an UL; and the UL UE may be simultaneously receiving a DL. However, for ease of discussion, only the DL reception of the DL UE will be discussed; and only the UL transmission of the UL UE will be discussed.

As discussed above, in a cell activating full duplex a DL UE generally suffers from co-channel interference, or inter-UE interference, from a paired UL UE (i.e., a UE transmitting a UL transmission on the same full duplex carrier). Here, a DL UE and UL UE are considered to be paired with one another if the UL UE transmits its UL at the same time, and on at least a portion of the same resources on which the DL UE receives its DL or on a resource so close to the resource on which the DL UE receives its DL that the transmission of the UL signal can impact the reception of DL signal. The strength of this inter-UE interference depends on the distance between the aggressor (UL) and victim (DL) UEs. The interference further depends on the aggressor UE's UL Tx beamforming, if used. And, if the victim UE has more than one receive antenna and performs coherent antenna reception, the interference strength also depends on the spatial direction of the interference signal. Accordingly, a victim UE, and not a base station, can have a capability to directly characterize interference from an aggressor UE to the victim UE.

To address inter-UE interference between cells, NR Rel-16 specifications introduce a feature called cross-link interference (CLI) handling. CLI handling provides an approach for a UE in one cell to measure interference from UEs in other cells. For example, a network may configure a set of SRS resources for both DL UEs and the UL UEs. Here, the respective SRS configurations can be coordinated between the aggressor and victim cells via a backhaul connection between the respective base stations. Accordingly, the network configures DL UEs to measure the strength of SRS signals from UL UEs in neighboring cells.

With this scheme for CLI handling, two paired UEs are located in two different cells. Accordingly, to coordinate the SRS resource configuration across UEs in different cells and enable such inter-cell SRS measurements, the cells' base stations communicate with one another through a backhaul connection. Considering backhaul data rate and latency restrictions, with this CLI handling scheme, in existing specifications for NR a victim UE can only report a layer-3 measurement result to an aggressor cell, i.e. the values of an SRS reference signal received power (SRS-RSRP) or a CLI received signal strength indicator (CLI-RSSI). Here, the victim UE generates these layer-3 measurement results based on the results of long-term measurements (e.g., over a duration of tens or even hundreds of slots). And furthermore, due to backhaul transfer latency restrictions, in existing specifications for NR the information transfer between victim and aggressor cells in CLI handling can only take a static or semi-static mode. Correspondingly, the network can only configure a victim UE's SRS measurement in a static or semi-static pattern. Therefore, the above-described CLI handling techniques may be suitable for long-term interference management, e.g., where a network allocates non-overlapping radio resources to an aggressor UE and a victim UE.

However, an improved inter-UE interference handling technique, such as provided in the present disclosure, can increase the system capacity relative to these CLI handling techniques by enabling radio resource reuse in a full duplex scheme. By thereby essentially doubling each single-link capacity, full duplexing with the presently disclosed inter-UE interference handling can increase the system throughput in diverse applications in wireless communication networks, and also reduce the transfer latency for time critical services.

In some previously disclosed examples, a base station may transmit an instruction to a DL UE (i.e., a victim UE) in full duplex mode to measure inter-UE interference based on SRS reception from an UL UE (i.e., an aggressor UE). The victim UE may then add an SRS resource indicator (SRI) in a CSI report it transmits to the BS, to indicate the selection of a matched UL UE (aggressor UE). With this information from the CSI report, the base station can suitably schedule the DL UE (victim UE) and the UL UE (aggressor UE) to reduce or avoid inter-UE interference, and accordingly, improve link capacity.

However, according to an aspect of the present disclosure, further improvements to the link capacity achieved by a full duplex scheduler may be obtained not only by a proper selection of paired UEs, but also by a proper determination of the respective transport formats to be used by the paired UEs (e.g., transmission power, transmission beams, beam directions, MIMO schemes, MCS values, etc.). For example, a base station may transmit a set of one or more candidate UL parameters or DL parameters to a DL UE (i.e., a victim UE) in a full duplex network. Based on the set of one or more candidate UL parameters or DL parameters, the victim UE may then determine a preferred hypothesis for CSI reporting. Here, a preferred hypothesis for CSI reporting may correspond to a DL UE selection of a preferred transmission parameter for the base station to utilize to configure the DL (victim) UE or the UL (aggressor) UE based on the DL UE's corresponding projected DL reception performance when facing inter-UE interference from the UL UE.

However, previous examples of this scheme, providing for a base station to determine transport formats based a victim UE's hypothesis for CSI reporting, have based the victim UE's hypothesis on a single dimension or factor. For example, such a hypothesis has been based on either a DL parameter (i.e., a selected configuration parameter for a DL to be received by the victim UE experiencing inter-UE interference from the aggressor UE) or an UL parameter (i.e., a selected parameter for an interfering UL transmission received by the victim UE as interference). Because they only rely on a single dimension or factor, these schemes can potentially result in a base station achieving a less than optimal scheduling result (e.g., a less than optimal link capacity in a full duplex link).

Therefore, an aspect of the present disclosure provides for CSI reporting based on a two-dimensional hypothesis, e.g., based on both a DL parameter and an UL parameter. This can provide additional flexibility and accuracy for a base station's scheduler. That is, a base station can achieve improved link capacity by jointly determining DL and UL transport formats in a full duplex network by utilizing CSI reporting from a victim UE based on a multiple-dimensional hypothesis. For example, a transmit power of a DL channel in a full duplex network impacts not only the DL channel power gain, but furthermore, also impacts the self-interference the base station experiences. That is, while an increased DL transmit power can provide for increased DL channel power gain, it can also increase interference of the base station's DL transmission on its own UL reception in a full duplex network. And similarly, a beam parameter that a base station allocates to an UL UE for its UL transmission in a full duplex network impacts not only the UL UE's UL channel beamforming gain, but also impacts the inter-UE interference experienced at a DL UE receiving a DL in a full duplex network. Therefore, when a base station takes these considerations into account and jointly determines transport formats for both a DL resource allocation to a DL UE and an UL resource allocation to an UL UE, the base station can further increase link capacity (e.g., by increasing the total DL-plus-UL throughput) in a full duplex network. Thus, the base station's joint determination of those DL and UL transport formats based on a two-dimensional hypothesis, as described herein, can provide for improved link capacity.

In some examples, a UE may provide a full two-dimensional hypothesis, or set of full two-dimensional hypotheses, in a CSI report. However, providing such full two-dimensional hypotheses can result in an unacceptably large payload in a CSI report. Accordingly, some further aspects of the present disclosure provide for a UE to generate a CSI report based on a two-dimensional hypothesis in an efficient manner with reduced signaling overhead.

As discussed above, a victim UE, and not a base station, may have a capability to directly characterize interference from an aggressor UE to the victim UE. Therefore, in some aspects of this disclosure, the victim UE may determine and indicate to the base station a CSI report including parameters that take into account a received interfering transmission from an aggressor UL UE in a full duplex network. That is, the victim UE may transmit to the base station a DL-plus-UL two-dimensional hypothesis for DL transfer and UL transfer in full duplex. With this information from the victim UE, a base station may jointly determine transport formats of a paired UL UE and DL UE in full duplex.

In various examples, one dimension of the two-dimensional hypothesis described herein may correspond to a DL the base station transmits to the DL (victim) UE in a full duplex network. Any suitable parameter or parameters corresponding to the DL may correspond to a DL dimension of a two-dimensional hypothesis within the scope of the present disclosure. As one example, one dimension of the two-dimensional hypothesis may correspond to a Tx power of the DL. And in some examples, a second dimension of the two-dimensional hypothesis may correspond to one or more UL parameters of an UL that an UL (aggressor) UE transmits to the base station in a full duplex network. Any suitable parameter or parameters corresponding to the UL may correspond to an UL dimension of a two-dimensional hypothesis within the scope of the present disclosure. As some examples, a second dimension of the two-dimensional hypothesis may correspond to one or more of an UL beam direction, an UL beam width, an UL beam Tx power, a number of layers in the UL beam, etc., of the paired UL UE. Once a base station receives a CSI report including information corresponding to such a two-dimensional hypothesis, the base station may choose to utilize one selected by DL UE itself, or may choose to utilize different parameters for configuration of the respective UL and DL UEs. In either case, the base station may accordingly jointly determine a DL parameter for the DL UE and an UL parameter for the UL UE based on a selected two-dimensional hypothesis.

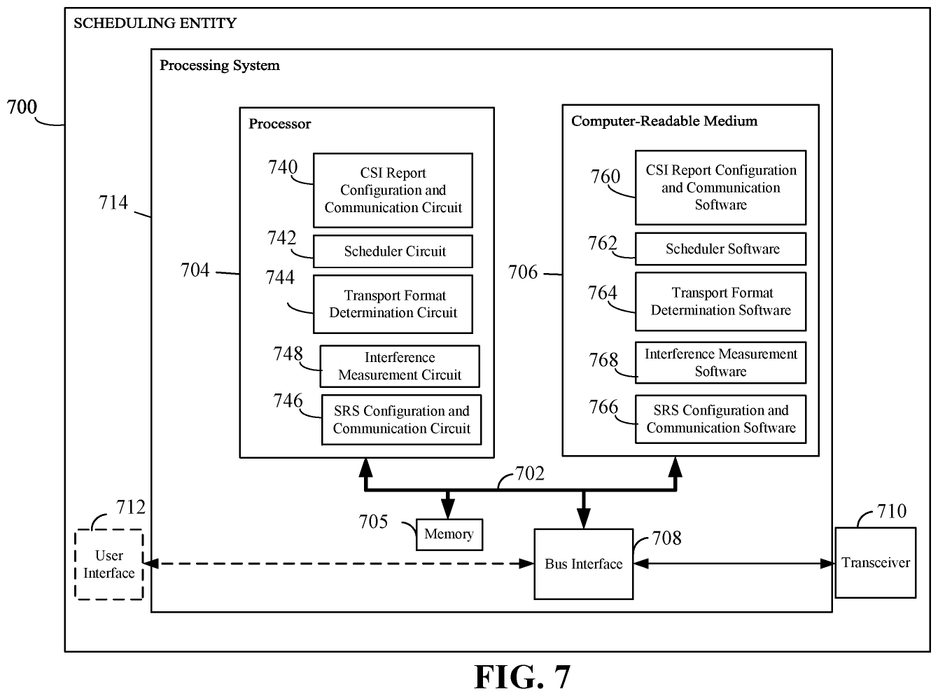

FIG. 7 is a block diagram illustrating an example of a hardware implementation for a scheduling entity 700 employing a processing system 714. For example, the scheduling entity 700 may be a user equipment (UE) as illustrated in any one or more of FIGS. 1, 2, 3, 5, and/or 6. In another example, the scheduling entity 700 may be a base station as illustrated in any one or more of FIGS. 1, 2, 3, 5, and/or 6. And in some examples, the scheduling entity 700 may be an IAB node as illustrated in any one or more of FIGS. 5 and/or 6.

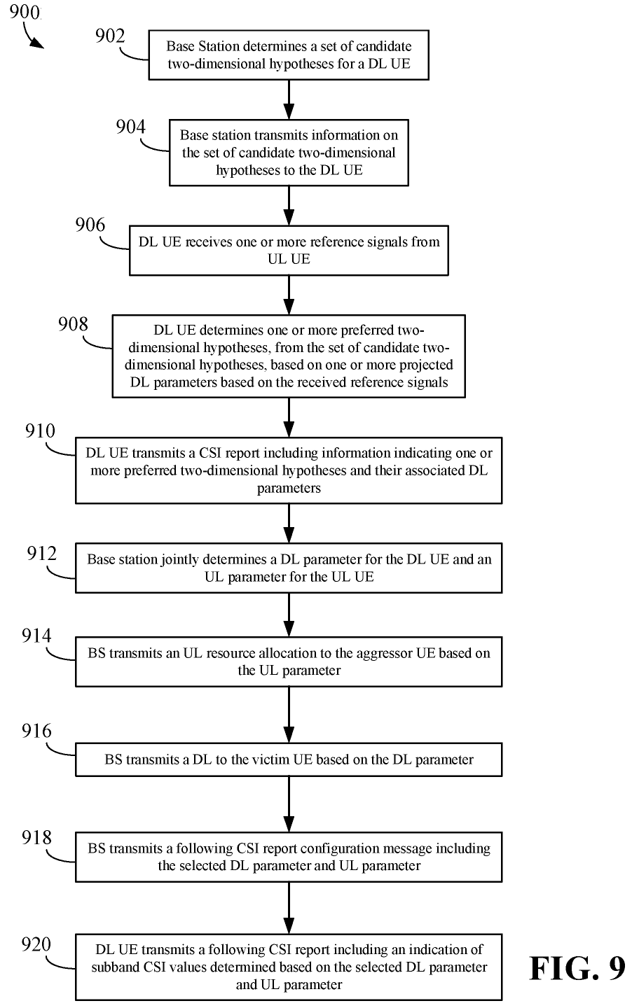

The scheduling entity 700 may include a processing system 714 having one or more processors 704. Examples of processors 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 700 may be configured to perform any one or more of the functions described herein. That is, the processor 704, as utilized in a scheduling entity 700, may be configured (e.g., in coordination with the memory 705) to implement any one or more of the processes and procedures described below and illustrated in FIGS. 9-17.

The processing system 714 may be implemented with a bus architecture, represented generally by the bus 702. The bus 702 may include any number of interconnecting buses and bridges depending on the specific application of the processing system 714 and the overall design constraints. The bus 702 communicatively couples together various circuits including one or more processors (represented generally by the processor 704), a memory 705, and computer-readable media (represented generally by the computer-readable medium 706). The bus 702 may also link various other circuits such as timing sources, peripherals, voltage regulators, and power management circuits, which are well known in the art, and therefore, will not be described any further. A bus interface 708 provides an interface between the bus 702 and a transceiver 710. The transceiver 710 provides a communication interface or means for communicating with various other apparatus over a transmission medium. Depending upon the nature of the apparatus, a user interface 712 (e.g., keypad, display, speaker, microphone, joystick) may also be provided. Of course, such a user interface 712 is optional, and some examples, such as a base station, may omit it.

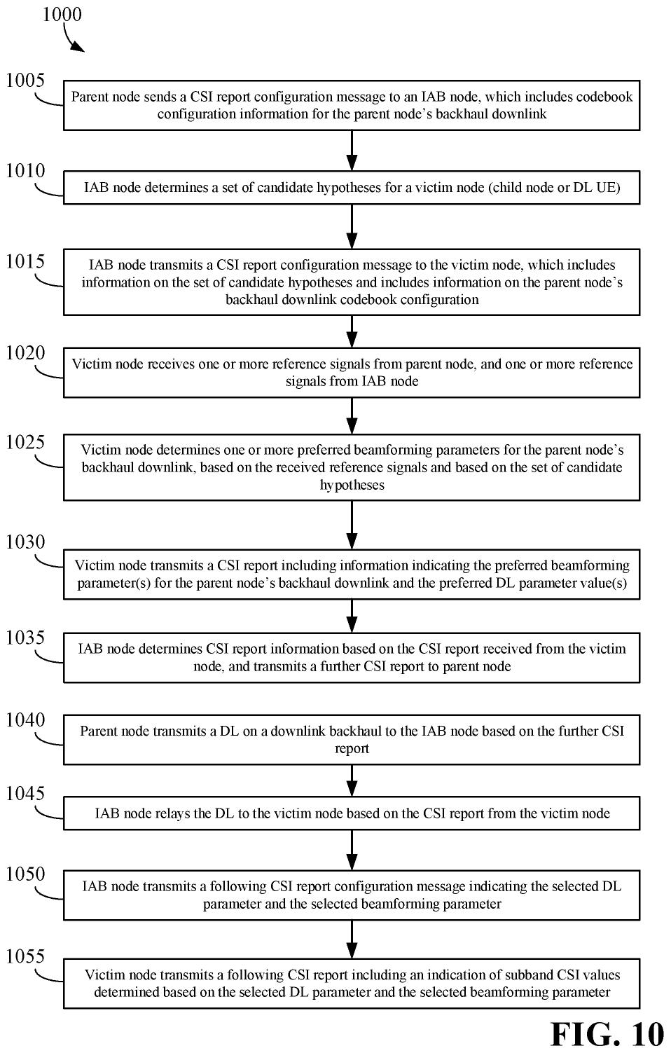

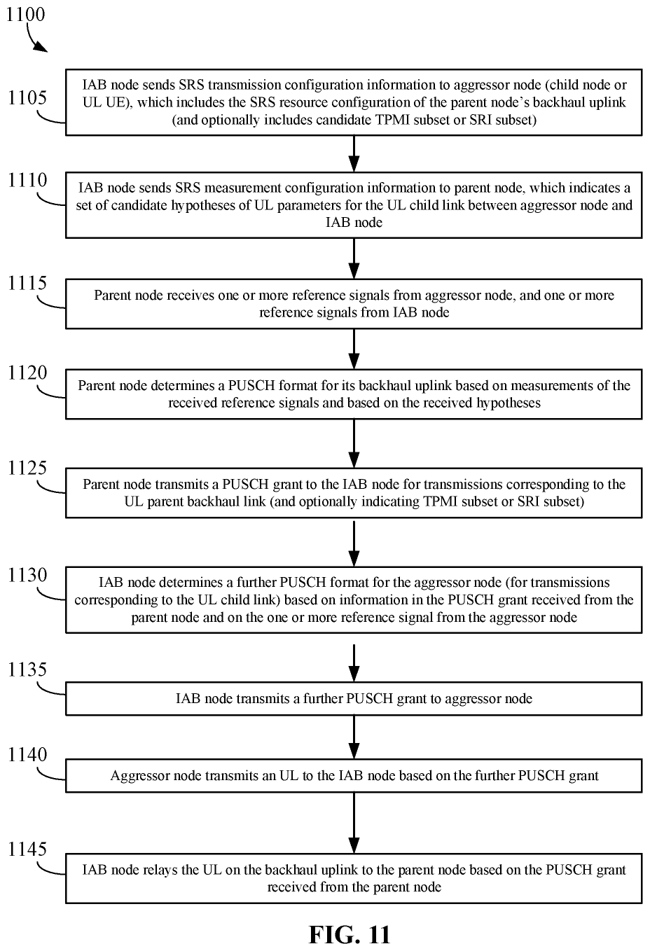

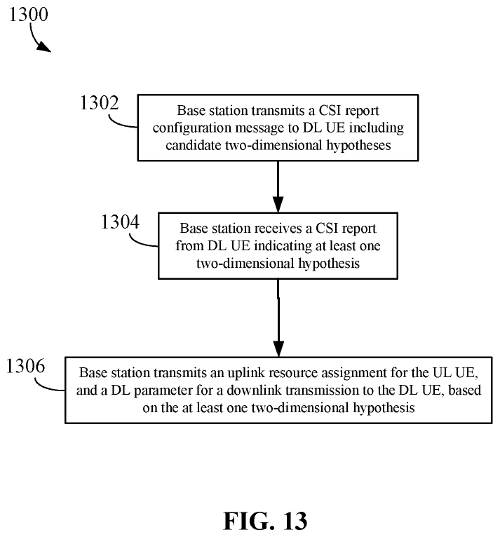

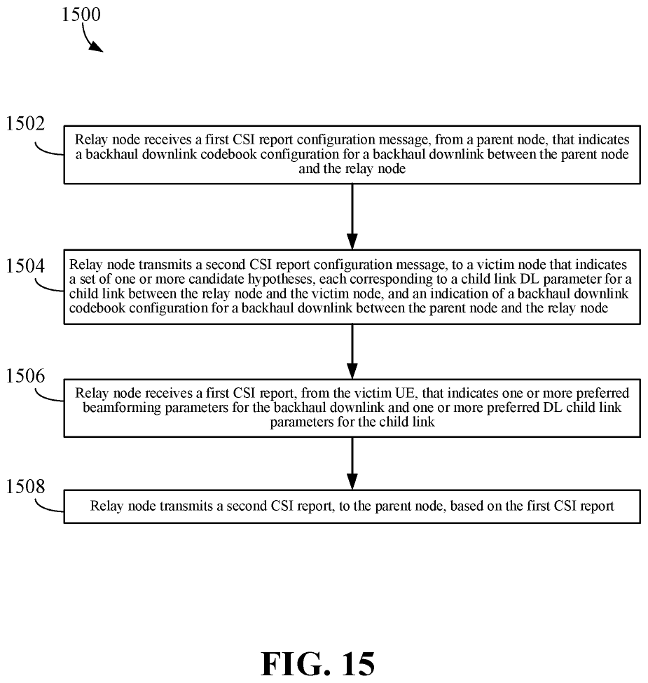

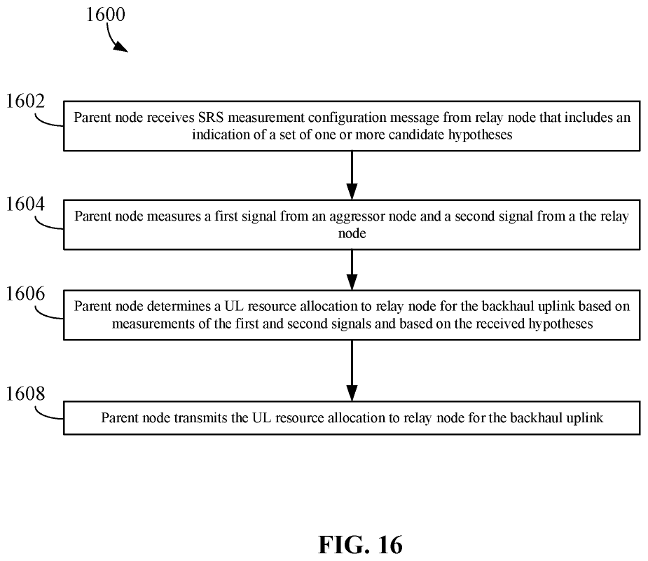

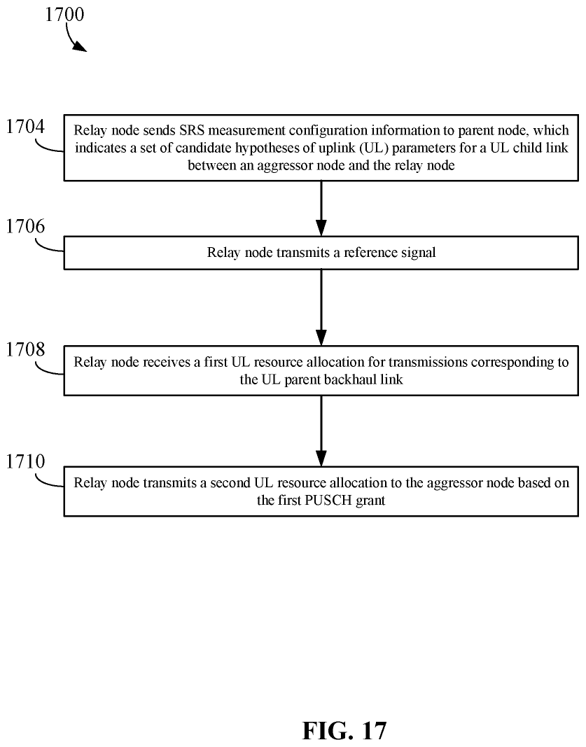

In some aspects of the disclosure, the processor 704 may include CSI report configuration and communication circuitry 740 configured (e.g., in coordination with the memory 705) for various functions, including, e.g., determining a set of candidate two-dimensional hypotheses for CSI reporting, transmitting a CSI report configuration message including an indication of a set of candidate two-dimensional hypotheses, and/or receiving a CSI report including an indication of a set of preferred two-dimensional hypotheses from the set of candidate two-dimensional hypotheses. In some examples, the CSI report configuration and communication circuitry 740 may further receive a CSI report including a set of one or more DL transmission parameters corresponding to the set of preferred two-dimensional hypotheses. For example, the CSI report configuration and communication circuitry 740 may be configured to implement one or more of the functions described below in relation to FIG. 9, including, e.g., blocks 902, 904, and/or 918; in relation to FIG. 10, including, e.g., blocks 1005, 1010, 1015, 1035, and/or 1050; in relation to FIG. 13, including, e.g., blocks 1302 and/or 1304; and/or in relation to FIG. 15, including, e.g., blocks 1502, 1504, 1506, and/or 1508. The processor 704 may further include scheduler circuitry 742 configured (e.g., in coordination with the memory 705) for various functions, including, e.g., determining an UL resource allocation for an aggressor UE and/or determining a DL resource allocation for a victim UE in full duplex. For example, the scheduler circuitry 742 may be configured to implement one or more of the functions described below in relation to FIG. 9, including, e.g., blocks 914 and/or 916; in relation to FIG. 10, e.g., including blocks 1040 and/or 1045; in relation to FIG. 11, e.g., including blocks 1125, 1135, and/or 1145; in relation to FIG. 13, e.g., including block 1306; in relation to FIG. 16, e.g., including block 1608; and/or in relation to FIG. 17, e.g., including blocks 1708 and/or 1710. The processor 704 may further include transport format determination circuitry 744 configured (e.g., in coordination with the memory 705) for various functions, including, e.g., jointly determining a transport format for a DL transmission to a victim UE and a transport for an UL transmission from an aggressor UE based on a projected combined throughput of the DL transmission and the UL transmission based on a DL transmission parameter received from the victim UE. For example, the transport format determination circuitry 744 may be configured to implement one or more of the functions described below in relation to FIG. 9, including, e.g., blocks 912, 914, 916, and/or 918; in relation to FIG. 11, e.g., including blocks 1120 and/or 1130; and/or in relation to FIG. 16, e.g., including block 1606. The processor 704 may further include SRS configuration and communication circuit 746 configured (e.g., in coordination with the memory 705) for various functions, including, e.g., transmitting an SRS transmission configuration message, transmitting and/or receiving an SRS measurement configuration message, and transmitting a reference signal (e.g., an SRS). For example, the SRS configuration and communication circuit 746 may be configured to implement one or more of the functions described below in relation to FIG. 11, including, e.g., blocks 1105 and/or 1110; in relation to FIG. 16, e.g., including block 1602; and/or in relation to FIG. 17, e.g., including blocks 1704 and/or 1706. The processor 704 may further include interference measurement circuit 748 configured (e.g., in coordination with the memory 705) for various functions, including, e.g., receiving and measuring references signals (e.g., SRSs) from an aggressor node and an IAB node. For example, the interference measurement circuit 748 may be configured to implement one or more of the functions described below in relation to FIG. 11, including, e.g., block 1115; and/or in relation to FIG. 16, e.g., including block 1604.

The processor 704 is responsible for managing the bus 702 and general processing, including the execution of software stored on the computer-readable medium 706. The software, when executed by the processor 704, causes the processing system 714 to perform the various functions described below for any particular apparatus. The processor 704 may also use the computer-readable medium 706 and the memory 705 for storing data that the processor 704 manipulates when executing software.

One or more processors 704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 706. The computer-readable medium 706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 706 may reside in the processing system 714, external to the processing system 714, or distributed across multiple entities including the processing system 714. The computer-readable medium 706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 706 may store computer-executable code that includes CSI report configuration and communication software 760 configured for various functions, including, e.g., determining a set of candidate two-dimensional hypotheses for CSI reporting, transmitting a CSI report configuration message including an indication of a set of candidate two-dimensional hypotheses, and/or receiving a CSI report including an indication of a set of preferred two-dimensional hypotheses from the set of candidate two-dimensional hypotheses. In some examples, the CSI report configuration and communication software 760 may further receive a CSI report including a set of one or more DL transmission parameters corresponding to the set of preferred two-dimensional hypotheses. For example, the CSI report configuration and communication software 760 may be configured to cause a scheduling entity 700 to implement one or more of the functions described below in relation to FIG. 9, including, e.g., block 902, 904, and/or 918 in relation to FIG. 10, including, e.g., blocks 1005, 1010, 1015, 1035, and/or 1050; in relation to FIG. 13, including, e.g., blocks 1302 and/or 1304; and/or in relation to FIG. 15, including, e.g., blocks 1502, 1504, 1506, and/or 1508. The computer-readable storage medium 706 may further store computer-executable code that includes scheduler software 762 configured for various functions, including, e.g., determining an UL resource allocation for an aggressor UE and/or determining a DL resource allocation for a victim UE in full duplex. For example, the scheduler software 762 may be configured to cause a scheduling entity 700 to implement one or more of the functions described below in relation to FIG. 9, including, e.g., blocks 914 and/or 916; in relation to FIG. 10, e.g., including blocks 1040 and/or 1045; in relation to FIG. 11, e.g., including blocks 1125, 1135, and/or 1145; in relation to FIG. 13, e.g., including block 1306; in relation to FIG. 16, e.g., including block 1608; and/or in relation to FIG. 17, e.g., including blocks 1708 and/or 1710. The computer-readable storage medium 706 may further store computer-executable code that includes transport format determination software 764 configured for various functions, including, e.g., jointly determining a transport format for a DL transmission to a victim UE and a transport for an UL transmission from an aggressor UE based on a projected combined throughput of the DL transmission and the UL transmission based on a DL transmission parameter received from the victim UE. For example, the transport format determination software 764 may be configured to cause a scheduling entity 700 to implement one or more of the functions described below in relation to FIG. 9, including, e.g., blocks 912, 914, 916, and/or 918; in relation to FIG. 11, e.g., including blocks 1120 and/or 1130; and/or in relation to FIG. 16, e.g., including block 1606. The computer-readable storage medium 706 may further store computer-executable code that includes SRS configuration and communication software 766 configured for various functions, including, e.g., transmitting an SRS transmission configuration message, transmitting and/or receiving an SRS measurement configuration message, and transmitting a reference signal (e.g., an SRS). For example, the SRS configuration and communication software 766 may be configured to cause the scheduling entity 700 to implement one or more of the functions described below in relation to FIG. 11, including, e.g., blocks 1105 and/or 1110; in relation to FIG. 16, e.g., including block 1602; and/or in relation to FIG. 17, e.g., including blocks 1704 and/or 1706. The computer-readable storage medium 706 may further store computer-executable code that includes interference measurement software 768 configured for various functions, including, e.g., receiving and measuring references signals (e.g., SRSs) from an aggressor node and an IAB node. For example, the interference measurement software 768 may be configured to cause the scheduling entity 700 to implement one or more of the functions described below in relation to FIG. 11, including, e.g., block 1115; and/or in relation to FIG. 16, e.g., including block 1604.

In one configuration, the scheduling entity or base station 700 configured for wireless communication includes means for transmitting a channel state information (CSI) report configuration message to a victim user equipment (UE), including an indication of one or more candidate two-dimensional hypotheses, each corresponding to a DL parameter for a DL transmission to the victim UE and an UL parameter for an UL transmission from an aggressor UE in full duplex; means for receiving a CSI report from the victim UE, including an indication of at least one preferred two-dimensional hypothesis from the one or more candidate two-dimensional hypotheses; and means for determining an UL parameter for an uplink resource assignment for the aggressor UE, and a DL parameter for a downlink transmission to the victim UE, based on the at least one preferred two-dimensional hypothesis.

In another configuration, the scheduling entity or base station 700 configured for wireless communication includes means for receiving a first channel state information (CSI) report configuration message, from a parent node, including an indication of a backhaul downlink codebook configuration for a backhaul downlink between the parent node and the relay node; and means for transmitting a second channel state information (CSI) report configuration message, to a wireless communication victim node (victim node). The CSI report configuration message includes an indication of a set of one or more candidate hypotheses, each corresponding to a child link downlink (DL) parameter for a child link between the relay node and the victim node, and an indication of a backhaul downlink codebook configuration for a backhaul downlink between the parent node and the relay node. The scheduling entity or base station 700 further include means for receiving a first CSI report, from the victim UE, including an indication of one or more preferred beamforming parameters for the backhaul downlink and one or more preferred DL child link parameters for the child link; and means for transmitting a second CSI report, to the parent node, based on the first CSI report.

In another configuration, the scheduling entity or base station 700 configured for wireless communication includes means for receiving a sounding reference signal (SRS) measurement configuration message, where the SRS measurement configuration message includes an indication of a set of one or more candidate hypotheses, each corresponding to a child link uplink (UL) parameter for an UL child link between a relay node and an aggressor node. The scheduling entity or base station 700 further includes means for measuring a first signal received from the aggressor node and a second signal received from the relay node; means for determining a UL resource allocation to the relay node based on the measurements of the first and second signals and on the set of candidate hypotheses; and means for transmitting the UL resource allocation to the relay node.

In another configuration, the scheduling entity or base station 700 configured for wireless communication includes means for to transmitting a sounding reference signal (SRS) measurement configuration message, to a parent node, where the SRS measurement configuration message includes an indication of a set of candidate hypotheses of uplink (UL) parameters for a UL child link between an aggressor node and the relay node. The scheduling entity or base station 700 further include means for transmitting a first reference signal; means for receiving a first UL resource allocation, from the parent node, corresponding to a backhaul uplink between the parent node and the relay node; and means for transmitting a second UL resource allocation, to the aggressor node, based on the first UL resource allocation, the second UL resource allocation corresponding to the UL child link between the relay node and the aggressor node.

In one aspect, the aforementioned means may be the processor 704 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2, 3, 5, 6, and/or 7, and utilizing, for example, the processes and/or algorithms described herein in relation to FIGS. 9-17.

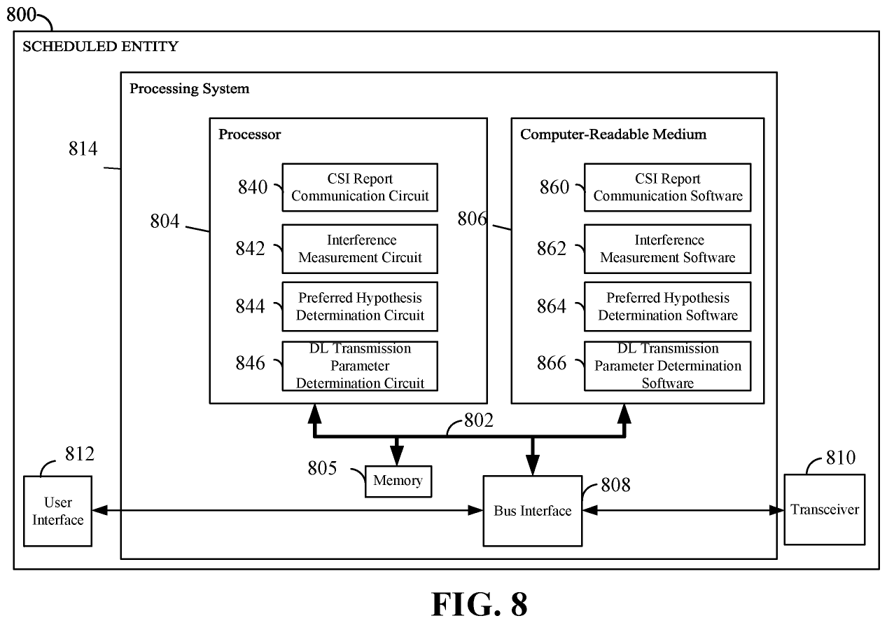

FIG. 8 is a conceptual diagram illustrating an example of a hardware implementation for an exemplary scheduled entity 800 employing a processing system 814. In accordance with various aspects of the disclosure, a processing system 814 may include an element, or any portion of an element, or any combination of elements having one or more processors 804. For example, the scheduled entity 800 may be a user equipment (UE) as illustrated in any one or more of FIGS. 1, 2, 3, 5, and/or 6. And in some examples, the scheduled entity 800 may be an IAB node as illustrated in any one or more of FIGS. 5 and/or 6.

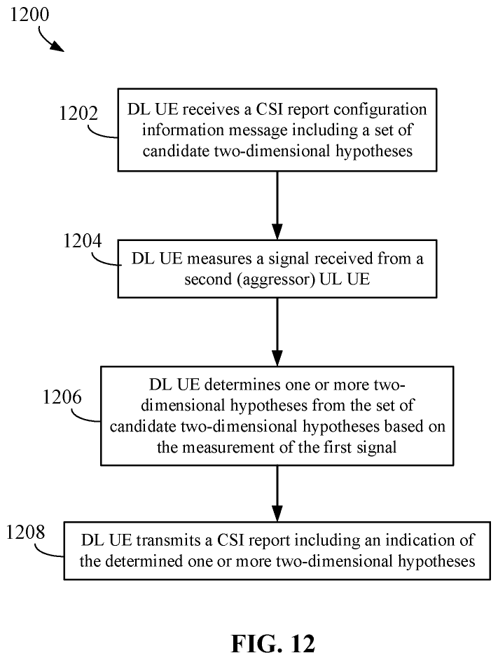

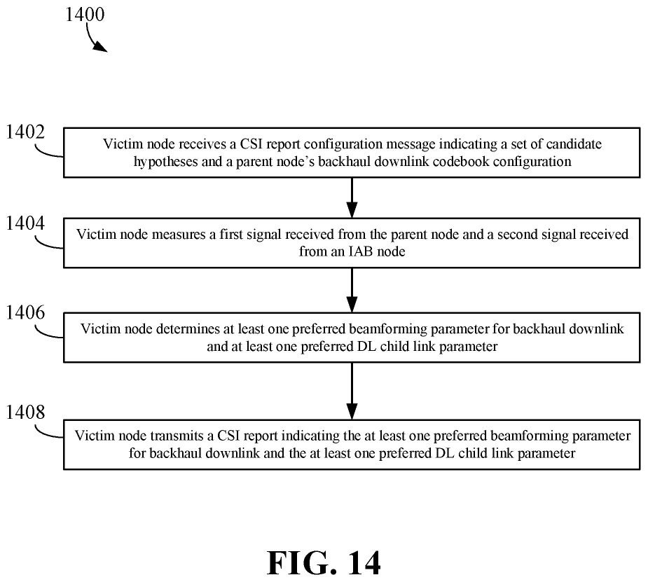

The processing system 814 may be substantially the same as the processing system 714 illustrated in FIG. 7, including a bus interface 808, a bus 802, memory 805, a processor 804, and a computer-readable medium 806. Furthermore, the scheduled entity 800 may include a user interface 812 and a transceiver 810 substantially similar to those described above in FIG. 7. That is, the processor 804, as utilized in a scheduled entity 800, may include CSI report communication circuitry 840 configured (e.g., in coordination with the memory 805) for various functions, including, e.g., receiving a CSI report configuration message including an indication of a set of candidate two-dimensional hypotheses, and/or transmitting a CSI report including an indication of a set of preferred two-dimensional hypotheses from the set of candidate two-dimensional hypotheses, and in some examples, an indication of one or more DL transmission parameters corresponding to the preferred two-dimensional hypotheses. For example, the CSI report communication circuitry 840 may be configured to implement one or more of the functions described below in relation to FIG. 9, including, e.g., blocks 904, 910, 918, and/or 920; in relation to FIG. 10, e.g., including blocks 1030 and/or 1055; in relation to FIG. 12, e.g., including blocks 1202 and/or 1208; and/or in relation to FIG. 14, e.g., including blocks 1402 and/or 1408. The processor 804 may further include interference measurement circuitry 842 configured (e.g., in coordination with the memory 805) for various functions, including, e.g., performing an interference measurement of a reference signal (e.g., an SRS and/or DMRS) received from an aggressor UE. For example, the interference measurement circuitry 842 may be configured to implement one or more of the functions described below in relation to FIG. 9, including, e.g., block 906; in relation to FIG. 10, e.g., including block 1020; in relation to FIG. 12, e.g., including block 1204; in relation to FIG. 14, e.g., including block 1404. The processor 804 may further include preferred hypothesis determination circuitry 844 configured (e.g., in coordination with the memory 805) for various functions, including, e.g., determining a set of preferred two-dimensional hypotheses from a set of candidate two-dimensional hypotheses based on an interference measurement. For example, the preferred hypothesis determination circuitry 844 may be configured to implement one or more of the functions described below in relation to FIG. 9, including, e.g., block 908; in relation to FIG. 10, e.g., including block 1025; and/or in relation to FIG. 12, e.g., including blocks 1206; and/or in relation to FIG. 14, e.g., including block 1406. The processor 804 may further include DL transmission parameter determination circuitry 846 configured (e.g., in coordination with the memory 805) for various functions, including, e.g., determining one or more DL transmission parameters (e.g., a RI, a PMI, a CQI, a wideband SINR, and/or a wideband DL spectrum efficiency), corresponding to respective two-dimensional hypotheses. For example, the DL transmission parameter determination circuitry 846 may be configured to implement one or more of the functions described below in relation to FIG. 9, including, e.g., blocks 908 and/or 920; in relation to FIG. 12, e.g., including block 1206; and/or in relation to FIG. 14, e.g., including block 1406.

Further, the computer-readable storage medium 806 may store computer-executable code that includes CSI report communication software 860 that configure a scheduled entity 800 for various functions, including, e.g., receiving a CSI report configuration message including an indication of a set of candidate two-dimensional hypotheses, and/or transmitting a CSI report including an indication of a set of preferred two-dimensional hypotheses from the set of candidate two-dimensional hypotheses, and in some examples, an indication of one or more DL transmission parameters corresponding to the preferred two-dimensional hypotheses. For example, the CSI report communication software 860 may be configured to implement one or more of the functions described below in relation to FIG. 9, including, e.g., blocks 904, 910, 918, and/or 920; in relation to FIG. 10, e.g., including blocks 1030 and/or 1055; in relation to FIG. 12, e.g., including blocks 1202 and/or 1208; and/or in relation to FIG. 14, e.g., including blocks 1402 and/or 1408. The computer-readable storage medium 806 may further store computer-executable code that includes interference measurement software 862 that configure a scheduled entity 800 for various functions, including, e.g., performing an interference measurement of a reference signal (e.g., an SRS and/or DMRS) received from an aggressor UE. For example, the interference measurement software 862 may be configured to implement one or more of the functions described below in relation to FIG. 9, including, e.g., block 906; in relation to FIG. 10, e.g., including block 1020; in relation to FIG. 12, e.g., including block 1204; in relation to FIG. 14, e.g., including block 1404. The computer-readable storage medium 806 may further store computer-executable code that includes include preferred hypothesis determination software 864 that configure a scheduled entity 800 for various functions, including, e.g., determining a set of preferred two-dimensional hypotheses from a set of candidate two-dimensional hypotheses based on an interference measurement. For example, the preferred hypothesis determination software 864 may be configured to implement one or more of the functions described below in relation to FIG. 9, including, e.g., block 908; in relation to FIG. 10, e.g., including block 1025; and/or in relation to FIG. 12, e.g., including blocks 1206; and/or in relation to FIG. 14, e.g., including block 1406. The computer-readable storage medium 806 may further store computer-executable code that includes include DL transmission parameter determination software 866 that configure a scheduled entity 800 for various functions, including, e.g., determining one or more DL transmission parameters (e.g., a RI, a PMI, a CQI, a wideband SINR, and/or a wideband DL spectrum efficiency), corresponding to respective two-dimensional hypotheses. For example, the DL transmission parameter determination software 866 may be configured to implement one or more of the functions described below in relation to FIG. 9, including, e.g., blocks 908 and/or 920; in relation to FIG. 12, e.g., including block 1206; and/or in relation to FIG. 14, e.g., including block 1406.

In one configuration, the scheduled entity 800 configured for wireless communication includes means for receiving a channel state information (CSI) report configuration information message including an indication of one or more candidate two-dimensional hypotheses, each corresponding to a DL parameter for a DL transmission to the UE and an UL parameter for an UL transmission from an aggressor UE in full duplex; means for performing an interference measurement of a signal received from the aggressor UE; means for determining one or more preferred two-dimensional hypotheses from the set of candidate two-dimensional hypotheses, based on the interference measurement; and means for transmitting a CSI report including an indication of the one or more preferred two-dimensional hypotheses.

In another configuration, the scheduled entity 800 configured for wireless communication includes means for receiving a channel state information (CSI) report configuration message, where the CSI report configuration message includes an indication of a set of one or more candidate hypotheses, each corresponding to a child link DL parameter for a child link between a relay node and the victim node, and an indication of a backhaul downlink codebook configuration for a backhaul downlink between a parent node and the relay node. The scheduled entity 800 further includes means for measuring a first signal received from the parent node and a second signal received from the relay node; means for determining one or more preferred beamforming parameters for the backhaul downlink and one or more preferred DL child link parameters for the child link based on the measurements of the first and second signals and on the set of candidate hypotheses; and means for transmitting a CSI report including an indication of the one or more preferred beamforming parameters for the backhaul downlink and the one or more preferred DL child link parameters for the child link.

In one aspect, the aforementioned means may be the processor 804 shown in FIG. 8 configured to perform the functions recited by the aforementioned means. In another aspect, the aforementioned means may be a circuit or any apparatus configured to perform the functions recited by the aforementioned means.

Of course, in the above examples, the circuitry included in the processor 804 is merely provided as an example, and other means for carrying out the described functions may be included within various aspects of the present disclosure, including but not limited to the instructions stored in the computer-readable storage medium 806, or any other suitable apparatus or means described in any one of the FIGS. 1, 2, 3, 5, 6, and/or 8, and utilizing, for example, the processes and/or algorithms described herein in relation to FIGS. 9-17.

FIG. 9 is a flow chart illustrating an exemplary process 900 for interference handling in a network configured for full duplex in accordance with some aspects of the present disclosure. As described below, some or all illustrated features may be omitted in a particular implementation within the scope of the present disclosure, and some illustrated features may not be required for implementation of all embodiments. In some examples, the process 900 may be carried out by a combination of the scheduling entity 700 illustrated in FIG. 7 and the scheduled entity 800 of FIG. 8. In some examples, the process 900 may be carried out by any suitable apparatus or means for carrying out the functions or algorithm described below.

At block 902, a base station may determine a set of one or more candidate two-dimensional (DL-plus-UL) hypotheses for a DL UE in a full duplex network. Here, a variety of suitable sets of two-dimensional parameters may be determined. For example, with respect to a DL dimension of such a two-dimensional hypothesis, a set of candidate hypotheses may correspond to a transmission power for the base station's DL transmission to the DL UE. In some examples, the candidate hypotheses may correspond to a selected scope or range of DL transmission powers. For example, the candidate hypothesis may indicate that the base station's DL transmission power is restricted to an identified scope. The base station may determine and provide to the DL UE a set of candidate hypotheses corresponding to any suitable range or scope of DL transmission power, including but not limited to a scope of 16 decibel milliwatts (dBm) to 46 dBm.

In a further example, with respect to an UL dimension of such a two-dimensional hypothesis, a set of candidate hypotheses may correspond to a suitable beam parameter for an interfering (with respect to the DL UE) UL transmission from a paired UE in a full duplex network. Here, the candidate hypotheses may correspond to an UL beam direction of the paired UE's PUSCH transmission. In some examples, the candidate hypotheses may correspond to a selected scope or range of beam directions. For example, the candidate hypothesis may indicate that the UL UE's UL beam direction may be restricted to an identified range of directions. In an example where the UL UE's PUSCH type is codebook-based, then the candidate hypotheses may correspond to a set of candidate transmit precoding matrix indices (TPMIs) because there can be more than one port in codebook-based SRS. And, in an example where the UL UE's PUSCH type is non-codebook-based, then the candidate hypotheses may correspond to a set of candidate SRIs because there is only one port in non-codebook-based SRS.

In various aspects of this disclosure, the set of candidate two-dimensional hypotheses may include, for each candidate UL parameter a set of DL parameters that each differ from one another. For example, the base station may configure the DL UE with a different restricted subset of DL transmission powers for each candidate UL UE beam direction. Also, in some aspects of this disclosure, the set of candidate two-dimensional hypotheses may include, for each candidate DL transmission power, a set of candidate UL beam directions that each differ from one another. For example, the base station may configure the UL UE with a different restricted subset of UL beam directions for each candidate DL transmission power. In each of these examples, as further described below, the base station transmits the set of candidate two-dimensional hypotheses to the DL UE, e.g., in a message configuring the DL UE's CSI report. In a further aspect of the present disclosure, in some examples, a DL UE that receives such a set of candidate two-dimensional hypotheses may be restricted only to select the elements in the respective subsets for its CSI report transmission.

When a base station has selected a suitable set of candidate two-dimensional hypotheses, the base station may then order and index the values of those selected candidate hypotheses. In some examples, the base station may jointly code and quantize the two dimensions of the hypotheses. For example, a base station may first index DL transmission powers, and second index UL beam parameters. For example, if a set of two-dimensional hypotheses includes two DL transmission powers (or two DL transmission power scopes) and two UL beam directions (or two UL beam direction subsets), a base station may first index the two candidate DL transmission powers or power scopes as {1, 2}. Then, for each of these candidate DL transmission powers or power scopes, the base station may index the two candidate UL beam directions or direction ranges. Thus, the set of candidate two-dimensional hypotheses may include {DL Tx power 1, UL beam direction 1}, {DL Tx power 1, UL beam direction 2}, {DL Tx power 2, UL beam direction 1}, {DL Tx power 2, UL beam direction 2}. In another example, a base station may first index UL beam parameters, and second index DL transmission parameters. For example, for a set of two-dimensional hypotheses including the same two transmission powers (or two DL transmission power scopes) and two UL beam directions (or two UL beam direction subsets) as described above, a base station may first index the two candidate UL beam directions or beam ranges as {1, 2}. Then, for each of these candidate UL beam directions or direction ranges, the base station may index the two candidate DL transmission powers or power scopes. Thus, the set of candidate two-dimensional hypotheses may include {DL Tx power 1, UL beam direction 1}, {DL Tx power 2, UL beam direction 1}, {DL Tx power 1, UL beam direction 2}, {DL Tx power 2, UL beam direction 2}. In both of these two examples, the base station may encode the set of four candidate two-dimensional hypotheses with two (2) binary bits in sequence, as illustrated below in Table 1.

TABLE 1
Examples of Encoding Two-Dimensional Hypotheses

| | Index DL Tx Powers | Index UL Beam |
|---|---|---|
| Binary | First, | Parameters First, |
| Encoded | UL Beam Parameters | DL Tx Powers |
| Representation | Second | Second |
| 00 | {DL Tx power 1, | {DL Tx power 1, |
| | UL beam parameter 1} | UL beam direction 1} |
| 01 | {DL Tx power 1, | {DL Tx power 2, |
| | UL beam parameter 2} | UL beam direction 1} |
| 10 | {DL Tx power 2, | {DL Tx power 1, |
| | UL beam parameter 1} | UL beam direction 2} |
| 11 | {DL Tx power 2, | {DL Tx power 2, |
| | UL beam parameter 2} | UL beam direction 2} |

In a similar manner as above, a base station may jointly encode a set of selected candidate two-dimensional hypotheses that includes any suitable number of DL transmission powers and UL beam parameters.

In this manner, by introducing such specificity in the subset restrictions between the DL transmission power and the UL beam direction, the CSI report overhead for the DL UE CSI transmission may be reduced relative to one where a CSI report includes a full set of two-dimensional hypotheses. For example, if a base station provides for four (4) candidate DL transmission powers, the base station may encode those four values utilizing two bits. Here, if the base station provides for two (2) candidate UL beam directions, but each candidate UL beam direction is matched with only two out of the four candidate DL transmission powers, then a base station may reduce CSI report overhead by one bit relative to a CSI report without subset restriction, as illustrated in Table 2.

TABLE 2
Example of Subset Restriction

| Binary | | Binary | |
|---|---|---|---|
| Encoded | Without Subset | Encoded | With Subset |
| Representation | Restriction | Representation | Restriction |
| 000 | {DL Tx power 1, | 00 | {DL Tx power 1, |
| | UL beam parameter 1} | | UL beam direction 1} |
| 001 | {DL Tx power 1, | 01 | {DL Tx power 2, |
| | UL beam parameter 2} | | UL beam direction 1} |
| 010 | {DL Tx power 2, | 10 | {DL Tx power 3, |
| | UL beam parameter 1} | | UL beam direction 2} |
| 011 | {DL Tx power 2, | 11 | {DL Tx power 4, |
| | UL beam parameter 2} | | UL beam direction 2} |
| 100 | {DL Tx power 3, | | |
| | UL beam parameter 1} | | |
| 101 | {DL Tx power 3, UL | | |
| | beam parameter 2} | | |
| 110 | {DL Tx power 4, UL | | |
| | beam parameter 1} | | |
| 111 | {DL Tx power 4, UL | | |
| | beam parameter 2} | | |

At block 904, a base station may transmit information indicating the set of selected candidate two-dimensional hypotheses (e.g., a set of pairs of DL Tx power, and UL beam direction) to a DL (victim) UE. Here, the base station may utilize any suitable channel and signaling format for transmission of the candidate hypotheses. In some examples, the base station may transmit information indicating the set of selected candidate hypotheses within a CSI report configuration message, provided over RRC signaling. In this example, over RRC signaling, the base station may transmit the candidate hypotheses for any kind of CSI report from the DL UE, such as a periodic CSI report, a semi-persistent CSI report, or an aperiodic CSI report. In further examples, the base station may transmit information indicating the set of selected candidate hypotheses utilizing a MAC CE. In this example, over a MAC CE, the base station may transmit the candidate hypotheses for a semi-persistent CSI report. In further examples, the base station may transmit information indicating the set of selected candidate hypotheses utilizing a DCI carried on a PDCCH. In this example, over a DCI, the base station may transmit the candidate hypotheses for an aperiodic CSI report.

In a further aspect of this disclosure, the base station may further transmit to the victim UE information indicating resource usage of the aggressor UE for its SRS transmission. While the aggressor UE SRS resource usage information may accompany the two-dimensional hypothesis information in a single transmission or channel, this is not necessarily the case, and in some examples these data may be transmitted separately utilizing any suitable transmission format or scheme.

At block 906, a DL UE (e.g., victim UE) may receive one or more reference signals (e.g., an SRS, a DMRS, etc.) at resources allocated to a selected UL UE (e.g., aggressor UE) for its transmission of reference signals.

At block 908, the DL UE may determine one or more preferred two-dimensional hypotheses from among the received candidate two-dimensional hypotheses. For example, the DL UE may measure or characterize the one or more reference signals received from the UL (aggressor) UE. Based on this measurement, the DL UE may take projected inter-UE interference from the UL UE into account, and determine a set of one or more projected DL parameters (e.g., a wideband DL parameter such as a DL wideband SINR, a DL spectrum efficiency, etc.; or a subband DL parameter such as RI/PMI/CQI) corresponding to each candidate hypothesis of the set of candidate two-dimensional hypotheses received from the base station at block 902. For example, if a candidate two-dimensional hypothesis includes a DL Tx power of X dBm and a UL beam direction Y, the DL UE may project DL performance (e.g., wideband SINR, spectrum efficiency, RI/PMI/CQI, etc.) based on an assumption that the base station will transmit a PDSCH to the DL UE at a DL Tx power of X dBm, while the DL UE experiences inter-UE interference from the UL UE configured with UL beam direction Y.

Based on the one or more projected DL parameters, the DL UE may then select one or more two-dimensional hypotheses from the set of candidate two-dimensional hypotheses to be preferred two-dimensional hypotheses. For example, the UE may select the one or more candidate hypotheses that it projects will result in the highest DL wideband SINR, the largest DL spectrum efficiency, etc.

At block 910, the DL UE may transmit information indicating the one or more preferred two-dimensional hypotheses. While the DL UE may transmit information relating to any number of two-dimensional hypotheses, transmission of a small number of selected two-dimensional hypotheses can reduce signaling overhead. In some examples, the DL UE may further transmit information indicating the projected DL parameter(s) corresponding to each of the one or more preferred two-dimensional hypotheses. That is, the DL UE may transmit one or more triplets of information, including (1) a DL parameter for a PDSCH to the DL UE; (2) an UL parameter for a PUSCH from an UL UE; and (3) a DL parameter of the PDSCH based on the two-dimensional hypotheses corresponding to parts (1) and (2), projected based on a measured UL UE reference signal.

The DL UE may utilize any suitable channel or format for transmission of the one or more two-dimensional hypotheses and their corresponding DL parameter(s) in block 910. In some examples, the DL UE may transmit this information as a portion of a CSI report that the DL UE transmits to the base station.

In some examples, the DL UE's reporting format for the transmission at block 910 may utilize the encoding scheme the base station used in its transmission of candidate two-dimensional hypotheses to the DL UE. That is, the DL UE's report format may include, for example, a two-dimensional hypothesis index, selected from the two-dimensional hypothesis indexes received from the base station at block 902 above.

In an example where the DL UE transmits the information indicating the one or more two-dimensional hypotheses along with corresponding DL parameters, the DL UE's reporting format for the transmission at block 910 may further include an information element indicating the corresponding DL parameter. Here, the information element indicating a DL parameter may in some examples correspond to a wideband CSI value, such as a DL wideband SINR, a DL spectrum efficiency, etc. An information element indicating a projected DL parameter may in other examples correspond to a subband CSI value, such as a subband RI, a subband PMI, a subband CQI, etc. In the above examples, if a DL UE were to utilize a wideband CSI value for the projected DL parameter, the CSI report payload may be reduced relative to the utilization of a subband CSI value for the projected DL parameter. However, were the DL UE to transmit a CSI report including two-dimensional hypotheses and their corresponding wideband CSI values, then (as discussed further below) the DL UE may be required to transmit a following CSI report that includes the subband CSI values for a DL parameter hypothesis indicated by the base station.

At block 912, based on the message received from the DL UE, the base station may jointly determine a DL parameter for a DL resource allocation for the DL UE, and an UL parameter for a UL resource allocation for the UL UE. Here, by virtue of the report from the DL UE, the base station's scheduler may make an informed decision, based on the DL UE's measured inter-UE interference, regarding a trade-off between DL performance for a DL UE and UL performance for an UL UE in full duplex. For example, for instances where the DL parameter that the DL UE reports is a DL Tx power, it may be recognized that in general, the higher the DL Tx power, the better the DL performance (e.g., higher spectrum efficiency). And further, in general, the higher the DL Tx power, the worse the UL performance in full duplex due to the stronger self-interference the DL transmission causes. However, by taking the report from the DL UE into account, the base station may determine an UL parameter for the UL UE that reduces its impact on the DL performance without necessarily impacting the UL performance of the UL UE. For example, for instances where the UL parameter that the DL UE reports is a UL beam direction, the scheduler at the base station may be able to select a beam direction for the UL UE that reduces its inter-UE interference on the DL UE with little to no impact on the UL performance. That is, if the spatial direction of the UL UE's UL transfer channel is similar to the spatial direction of the inter-UE interference that the UL UE causes, the interests of the UL UE and the DL UE are in competition with one another. However, if the spatial direction of the UL UE's UL transfer channel is different from (e.g., orthogonal to) the direction of the inter-UE interference that the UL UE causes, then the interests of the UL UE and the DL UE are compatible with one another. Therefore, by taking factors such as these into account, the base station's scheduler may determine a DL parameter for the DL UE and an UL parameter for the UL UE that can strike a balance between DL and UL performance. In some examples, the base station's desired balance may be to obtain the largest DL-plus-UL throughput that can be achieved in the relevant transmissions in full duplex. And in other examples, the base station's desired balance may be to maintain a suitable DL over UL throughput ratio. Those of ordinary skill in the art will comprehend that the base station may strike any suitable balance between DL and UL performance based on the report from the DL UE.

At block 914, the base station may transmit an UL resource allocation to the UL (aggressor) UE, based on the determined UL parameter. For example, if the UL parameter corresponds to a beam direction, the base station may here provide for the UL UE to utilize precoding for its UL transmission in accordance with the selected beam direction. And at block 916, the base station may transmit a DL (e.g., PDSCH) to the DL (victim) UE, based on the determined DL parameter. For example, if the DL parameter corresponds to a DL Tx power, the base station may transmit a PDSCH configured according to the selected Tx power.

Blocks 918 and 920 are optional, and correspond to an example discussed above, where the CSI report the DL UE transmits in block 910 includes a wideband CSI value, such as a wideband SINR or a DL spectrum efficiency. As briefly discussed above, in this example, because the CSI report that the DL UE transmits at block 910 includes a wideband CSI value for the projected DL parameter, the DL UE may be required to transmit a following CSI report that includes the subband CSI values for a DL parameter hypothesis indicated by the base station. These blocks 918 and 920 provide for this circumstance. Here, at block 918, the base station may transmit a CSI report configuration message to the DL UE, indicating the selected two-dimensional hypothesis from block 912 discussed above, including a DL parameter and an UL parameter. For example, in an instance where the DL parameter corresponds to a DL Tx power, at block 918 the base station may transmit a CSI report configuration message to the DL UE including an indication of the selected DL Tx power parameter. And in an instance where the UL parameter corresponds to a UL beam direction, at block 918 the base station may transmit a CSI report configuration message to the DL UE including an indication of the selected UL beam direction. At block 920, the DL UE may perform procedures similar to some of those described above in relation to blocks 906-910 based on the two-dimensional hypothesis that the DL UE receives at block 918. That is, the DL UE may receive one or more reference signals from the UL UE. At this point, as discussed above in relation to block 914, the UL transmission from the UL UE is configured according to the selected UL parameter (e.g., UL beam direction). The DL UE may accordingly determine a set of subband CSI parameters for the following CSI report, based on the DL parameter and UL parameter values that the DL UE receives at block 918. The DL UE may then transmit a following CSI report to the base station, including an indication of the determined subband CSI parameters (e.g., CQI/RI/PMI) for configuration of the PDCCH.

FIG. 10 is a flow chart illustrating an exemplary process 1000 for interference handling in a network configured for full duplex in accordance with some aspects of the present disclosure. As described below, some or all illustrated features may be omitted in a particular implementation within the scope of the present disclosure, and some illustrated features may not be required for implementation of all embodiments. To assist in the description, the process 1000 is described with respect to the system 600 in FIG. 6A and, in particular, the IAB node 605, the parent node 610, and the child node 615. In some examples, each of the blocks of the process 1000 may be carried out by at least one selected from the IAB node 605, the parent node 610, and the child node 615. Additionally, in some examples, the IAB node 605 and the parent node 610 may be two respective instances of the scheduling entity 700 illustrated in FIG. 7, and the child node 615 may be an instance of the scheduled entity 800 illustrated in FIG. 8. Accordingly, in some examples, the process 1000 may be carried out by one or more of the scheduling entities 700 and scheduled entity 800. However, in some examples, the process 1000 may be carried out by any suitable apparatus or means for carrying out the functions or algorithm described below.

In the context of the process 1000 and the system 600 of FIG. 6A, the parent node 610 may also be referred to as an aggressor wireless communication node (aggressor node) 610, the DL UE or child node 615 may be referred to as victim wireless communication node (victim node) 615, and the IAB node 605 may be referred to as a wireless communication relay node (relay node) 605.

At block 1005, the parent node 610 sends a first CSI report configuration message to the IAB node 605. The first CSI report configuration message includes codebook configuration information for the backhaul downlink of the parent node 610. The codebook configuration information may include both a codebook type and related parameters. For example, the CSI report configuration message may indicate whether the IAB node 605 should use codebook type 1 (e.g., using a single codeword from a codebook) or codebook type 2 (e.g., using a combination of multiple codewords from a codebook) for the backhaul downlink, as well as provide other related parameters for the indicated codebook type.

At block 1010, the IAB node 605 determines a set of candidate hypotheses for the victim node 615. In some examples, the set of candidate hypotheses may include a set of one dimensional hypotheses, each having a child link DL parameter. Here, a variety of suitable DL parameters may be determined for serving as the child link DL parameters of the candidate hypotheses. In some examples, the candidate hypotheses for the child link DL parameter may correspond to a selected scope or range of DL transmission powers. For example, the candidate hypothesis may indicate that the transmission power (Tx power) in the DL child link between the IAB node 605 and victim node 615 is restricted to an identified scope. The IAB node 605 may determine and provide to victim node 615 a set of candidate hypotheses corresponding to any suitable range or scope of DL transmission power, including but not limited to a scope of 16 dBm to 46 dBm.

In some examples, the IAB node 605 may order and index the values of those the set of candidate hypotheses. In some examples, the IAB node 605 may encode the hypotheses such that a particular code (e.g., a binary value) indicates a particular DL transmission power (e.g., two bits may be used to specify one of four potential DL transmission powers).

At block 1015, the IAB node 605 transmits a second CSI report configuration message to the victim node 615. The second CSI report configuration message to the victim node 615 may include information indicating the set of candidate hypotheses. The second CSI report configuration message to the victim node 615 may further include information indicating the backhaul downlink codebook configuration for the parent node 610. The CSI report configuration message may be sent over RRC signaling, over MAC CE, or DCI, similar to the CSI report configuration message described with respect to block 905 of FIG. 9. The CSI report configuration message further provides information to the victim node 615 about future reference signals (e.g., CSI-RSs) to be transmitted by the parent node 610 and the IAB node 605, enabling the victim node 615 to measure these reference signals. For example, the information may indicate the resources (e.g., time and/or frequency resources) over which the reference signals will be transmitted by the parent node 610 and the IAB node 605.

In block 1020, the victim node 615 receives one or more reference signals from the parent node 610 and one or more reference signals from the IAB node 605. For example, the one or more reference signals from the parent node 610 may be CSI-RS. Additionally, in some examples, the one or more reference signals from the IAB node 605 may be CSI-RS. The resources over which the reference signals are transmitted may be indicated to the victim node 615 by the CSI report configuration message received in block 1015. In some examples, the IAB node 605 also receives the one or more reference signals from the parent node 610.

In block 1025, the victim node 615 determines one or more preferred beamforming parameters for the backhaul downlink of the parent node 610 and one or more preferred DL child link parameter values, based on the received reference signals and on the set of candidate hypotheses. For example, the victim node 615 may measure or characterize the one or more reference signals from the parent node 610 and/or the IAB node 605. For example, the victim node 615 may measure or categorize a strength of the reference signals.

Based on this measurement, the victim node 615 may take projected interference from the parent node 610 into account, and determine a set of one or more projected DL parameters (e.g., a wideband DL parameter such as a DL wideband SINR, a DL spectrum efficiency, etc.; or a subband DL parameter such as RI/PMI/CQI) corresponding to each pair of (i) a candidate hypothesis of the set of candidate hypotheses received from the IAB node 605 at block 1015 and (ii) a candidate beamforming parameter of a set of candidate beamforming parameters. For example, if a candidate hypothesis includes a DL Tx power of X dBm, the victim node 615 may project DL performance (e.g., wideband SINR, spectrum efficiency, RI/PMI/CQI, CSI-RS resource indicator (CRI), etc.) were the IAB node 605 to transmit a PDSCH to the victim node 615 at a DL Tx power of X dBm, while the victim node 615 were to experience interference from the backhaul downlink of the parent node 610 that is configured with codebook indicated in block 1015 for each of the candidate beamforming parameters. The IAB node 605 may provide the candidate beamforming parameters to the victim node 615, or the victim node 615 may determine the candidate beamforming parameters based on the indicated codebook for the parent node 610.

Based on the one or more projected DL parameters, the victim node 615 may then select one or more preferred beamforming parameters from the candidate beamforming parameters for the backhaul downlink of the parent node 610 and/or hypotheses from the set of candidate hypotheses to be preferred hypotheses. For example, the victim node 615 may select the one or more beamforming parameters and/or candidate hypotheses that it projects will result in the highest DL wideband SINR, the largest DL spectrum efficiency, etc. The beamforming parameters may include, for example, the preferred CSI-RS resource indicator (CRI), precoding matrix indicator (PMI), and (rank indicator) RI for the backhaul downlink.

In block 1030, the victim node 615 transmits a CSI report including information indicating the preferred beamforming parameter(s) for the backhaul downlink of the parent node 610 and the preferred DL parameter value(s) for the DL child link. In some examples, to indicate the preferred beamforming parameters, the victim node 615 includes one or more of a preferred CRI, PMI, and/or RI for the downlink backhaul of the parent node 610. In some examples, the victim node 615 includes one or more preferred hypotheses of the set of candidate hypotheses in the CSI report to indicate the preferred DL parameter value. In some examples, the victim node 615 may further include an information element indicating the corresponding DL child link parameter(s) associated with the candidate hypotheses in the CSI report. Here, the information element indicating DL child link parameter(s) may in some examples correspond to one or more of a wideband CSI value, such as a DL wideband SINR, a DL spectrum efficiency, etc. An information element indicating a projected DL parameter may in other examples correspond to a subband CSI value, such as a subband RI, a subband PMI, a subband CQI, etc.

In block 1035, the IAB node 605 determines CSI report information based on the CSI report received from the victim node 615, and transmits a further CSI report to the parent node 610. For example, IAB node 605 may determine CSI report information from the CSI report including one or more preferred DL parameter values (e.g., DL child link power transmission levels) and one or more preferred beam forming parameters for the parent node 610. The IAB 605 may then generate the further CSI report based on the determined CSI report information. The further CSI report may indicate preferred beamforming parameters (e.g., CRI, PMI, and/or RI) for the downlink backhaul of the parent node 610 that are preferred by the IAB node 605. In this further CSI report, the beamforming parameters indicated by the IAB node 605 may align with the preferred beamforming parameters indicated by the victim node 615. For example, the further CSI report may reuse the same beamforming parameters provided in the CSI report from the victim node 615, or the further CSI report may include a subset of the beamforming parameters provided in the CSI report from the victim node 615.

In block 1040, the parent node 610 transmits a DL on a downlink backhaul (e.g., PDSCH) to the IAB node 605 based on further CSI report from the IAB node 605. For example, the DL may be transmitted on the downlink backhaul according to the preferred beamforming parameters indicated in the further CSI report.

In block 1045, the IAB node 605 relays the DL on the child link from the parent node 610 to the victim node 615 based on the CSI report from the victim node 615. For example, the IAB node 605 may transmit the DL on the child link according to a DL Tx power indicated in the CSI report from the victim node 615.

Blocks 1050 and 1055 are optional, and correspond to an example where the CSI report the victim node 615 transmits in block 1030 includes a wideband CSI value, such as a wideband SINR or a DL spectrum efficiency. As discussed above with respect to blocks 918 and 920 of FIG. 9, in this example, because the CSI report that the victim node 615 transmits at block 1030 includes a wideband CSI value for the projected DL parameter, the victim node 615 may be required to transmit a following CSI report that includes the subband CSI values for a DL parameter hypothesis indicated by the IAB node 605. These blocks 1050 and 1055 provide for this circumstance. Here, at block 1050, the IAB node 605 may transmit a following CSI report configuration message to the victim node 615, indicating the selected DL parameter applied by the IAB node in block 1045 to relay the DL on the child link and indicating the selected beamforming parameters applied by the parent node to transmit the DL on the downlink backhaul in block 1040. At block 1055, the victim node 615 may perform procedures similar to some of those described above in relation to blocks 1015-1030 based on the hypothesis that the victim node 615 receives at block 1050. That is, the victim node 615 may receive one or more reference signals from the parent node 610. At this point, the downlink backhaul DL transmission from the parent node 610 may be configured according to the preferred beamforming parameters. The victim node 615 may accordingly determine a set of subband CSI parameters for the following CSI report, based on the DL parameters values that the victim node 615 receives at block 1050. The victim node 615 may then transmit a following CSI report to the IAB node 605, including an indication of the determined subband CSI parameters (e.g., CQI/RI/PMI) for configuration of the PDCCH.

FIG. 11 is a flow chart illustrating an exemplary process 1100 for interference handling in a network configured for full duplex in accordance with some aspects of the present disclosure. As described below, some or all illustrated features may be omitted in a particular implementation within the scope of the present disclosure, and some illustrated features may not be required for implementation of all embodiments. To assist in the description, the process 1100 is described with respect to the system 600 in FIG. 6B and, in particular, the IAB node 605, the parent node 610, and the victim node 615. In some examples, each of the blocks of the process 1100 may be carried out by at least one selected from the IAB node 605, the parent node 610, and the victim node 615. Additionally, in some examples, the IAB node 605 and the parent node 610 may be two respective instances of the scheduling entity 700 illustrated in FIG. 7, and the victim node 615 may be an instance of the scheduled entity 800 illustrated in FIG. 8. Accordingly, in some examples, the process 1100 may be carried out by one or more of the scheduling entities 700 and scheduled entity 800. However, in some examples, the process 1100 may be carried out by any suitable apparatus or means for carrying out the functions or algorithm described below.

In the context of the process 1100 and the system 600 of FIG. 6B, the parent node 610 may also be referred to as a victim wireless communication node (victim node), the UL UE or child node 615 may be referred to as an aggressor wireless communication node (aggressor node) 615, and the IAB node 605 may be referred to as a wireless communication relay node (relay node).

At block 1105, the IAB node 605 sends a sounding reference signal (SRS) transmission configuration message to the aggressor node 615. The SRS transmission configuration message indicates to the aggressor node 615 an SRS resource configuration of the backhaul uplink of the parent node 610. For example, the SRS transmission configuration message may indicate to the aggressor node 615 time and frequency resources over which the aggressor node 615 should transmit an SRS, such that the IAB node 605 and parent node 610 may receive and measure the SRS. In some examples, the SRS transmission configuration message further includes a candidate TPMI subset or a candidate SRI subset.

At block 1110, the IAB node 605 sends an SRS measurement configuration message to the parent node 610. For example, the SRS transmission configuration message may indicate to the parent node 610 the time and frequency resources over which the aggressor node 615 has been instructed to transmit an SRS, such that the parent node 610 may receive and measure the SRS. The SRS measurement configuration message further indicates a set of candidate hypotheses of UL parameters for SRS transmissions in the UL child link between the aggressor node 615 and the IAB node 605.

In some examples, the IAB node 605 determines the set of candidate hypotheses, which may include a set of one dimensional hypotheses, each having a child link UL parameter. Here, a variety of suitable UL parameters may be determined for serving as the UL parameters of the candidate hypotheses. For example, the child link UL parameter of the candidate hypotheses may correspond to a suitable beam parameter for an interfering (with respect to the backhaul uplink of the parent node 610) UL transmission from the aggressor node 615. In some examples, the candidate hypotheses may correspond to a selected scope or range of beam directions. For example, the candidate hypothesis may indicate that the UL beam direction of the aggressor node 615 may be restricted to an identified range of directions. In an example where the child node's PUSCH type is codebook-based, then the candidate hypotheses may correspond to a set of candidate transmit precoding matrix indices (TPMIs) because there can be more than one port in codebook-based SRS. And, in an example where the child node's PUSCH type is non-codebook-based, then the candidate hypotheses may correspond to a set of candidate SRIs because there is only one port in non-codebook-based SRS.

In some examples, the IAB node 605 may order and index the values of those selected candidate hypotheses for transmission. In some examples, the IAB node 605 may encode the hypotheses such that a particular code (e.g., a binary value) indicates a particular UL parameter (e.g., two bits may be used to specify one of four potential UL beam directions).

At block 1115, the parent node 610 receives one or more reference signals from the IAB node 605 and one or more reference signals from the aggressor node 615. For example, the one or more reference signals from the IAB node 605 may each be an SRS. Additionally, in some examples, the one or more reference signals from the aggressor node 615 may each be an SRS. As noted, the resources over which the reference signals from the aggressor node 615 are transmitted may be indicated to the parent node 610 by the SRS measurement configuration message received in block 1110 and may be indicated to the aggressor node 615 by the SRS transmission configuration message received in block 1105. In some examples, the IAB node 605 also receives the one or more reference signals from the aggressor node 615.

At block 1120, the parent node 610 determines a PUSCH format for the backhaul uplink of the parent node 610 (i.e., between the parent node 610 and the IAB node 605). For example, the parent node 610 may measure or characterize the one or more reference signals from the aggressor node 615 and/or the IAB node 605. For example, the parent node 610 may measure or categorize a strength of the reference signals. Based on these measurements or characterizations, the parent node 610 may take projected interference from the aggressor node 615 into account, and determine a set of one or more projected UL characteristics (e.g., a UL SINR, a UL spectrum efficiency, etc.) corresponding to each candidate hypothesis of the set of candidate hypotheses received from the IAB node 605 at block 1110.

Based on the one or more projected UL characteristics, the parent node 610 may then select a PUSCH format for the backhaul uplink of the parent node 610. For example, the parent node 610 may select a PUSCH format with a candidate UL parameter that, based on the projected UL characteristics, may result in the highest UL wideband SINR, the largest UL spectrum efficiency, etc.

In some examples, in block 1120, the parent node 610 optionally also determines a TPMI subset or SRI subset of the UL child link between the IAB 605 and the aggressor node 615 based on the measurements of the reference signals and the set of candidate hypotheses. For example, the parent node 610 may select a TPMI subset (for codebook-based PUSCH types) or a SRI subset (for non-codebook-based PUSCH types) from a set of candidate TPMI or SRI subsets for each of the candidate hypotheses and project UL characteristics for each pairing (of subset and candidate hypothesis) given the measurements of the reference signals. The parent node 610 may then select the pair of TPMI or SRI subset and candidate hypothesis that, based on the projected UL characteristics, may result in the highest UL performance (e.g., highest UL wideband SINR, the largest UL spectrum efficiency, etc.). The IAB node 605 may provide the candidate TPMI subsets and/or SRI subsets to the parent node 610, or the TPMI subsets and/or SRI subsets may be predefined and the parent node 610 may, for example, obtain them from a memory of the parent node 610 (e.g., the memory 705).

At block 1125, the parent node 610 transmits a PUSCH grant, based on the determined PUSCH format, to the IAB node 605 for UL transmissions corresponding to the backhaul uplink between the IAB node 605 and the parent node 610. For example, the PUSCH grant may include the PUSCH format determined in block 1120. In some examples, the PUSCH grant may indicate resources (e.g., time, frequency resources, and spatial resources) for an uplink transmission on the backhaul uplink. In some examples, the PUSCH grant may specify a UL parameter from the candidate hypotheses. In some examples, the parent node 610 optionally also transmits the TPMI subset or SRI subset determined in block 1120 to the IAB node 605.

At block 1130, the IAB node 605 determines a further PUSCH format for the aggressor node 615, for UL transmissions corresponding to the UL child link between the IAB node 605 and the aggressor node 615, based on information in the received PUSCH grant from the parent node 610 and/or based on one or more reference signals from the aggressor node 615. For example, the IAB node 605 determines the further PUSCH format based on the TPMI subset (for codebook-based PUSCH types) or SRI subset (for non-codebook-based PUSCH types), and/or based on an SRS from the aggressor node 615. For example, the IAB node 605 may measure or categorize a strength of the reference signal from the aggressor node 615 (e.g., transmitted in block 1115 and also received by the parent node 610). Based on these measurements or characterizations, and the TPMI or SRI subset, the IAB node 605 may determine the further PUSCH format for the aggressor node 605, e.g., the format that may provide desirable UL characteristics (e.g., UL SINR or UL spectrum efficiency, etc.). In some examples, when the parent node 610 does not transmit a TPMI subset or SRI subset to the IAB node 605, the IAB node may use the full TPMI set or SRI set, in combination with the reference signal received from the aggressor node 615 (as previously described), to determine the further PUSCH format. Again, based on these measurements or characterizations of the reference signal (e.g., the SRS from the aggressor node 605), and the TPMI or SRI full set, the IAB node 605 may determine the further PUSCH format for the aggressor node 605, e.g., the format that may provide desirable UL characteristics (e.g., UL SINR or UL spectrum efficiency, etc.). For example, the IAB node 605 may iterate through potential combinations of characteristics of the further PUSCH format based on the TPMI or SRI full set and the measurements or characterizations of the reference signal to select the further PUSCH format that provides desirable UL characteristics.

At block 1135, the IAB node 605 transmits a further PUSCH grant to the aggressor node 615 based on the determined further PUSCH format. The further PUSCH grant is for UL transmissions corresponding to the UL child link between the IAB node 605 and the aggressor node 615. For example, the further PUSCH grant may include the further PUSCH format determined in block 1120. In some examples, the further PUSCH grant may indicate resources (e.g., time, frequency resources, and spatial resources) for an uplink transmission on the backhaul uplink.

At block 1140, the aggressor node 615 may transmit an UL on the child link from the aggressor node 615 to the IAB node 605 based on the further PUSCH grant. For example, the aggressor node 615 may transmit the UL on the child link according to parameters set forth in the further PUSCH grant. For example, the processor 804 may transmit the UL via the transceiver 810.

At block 1145, the IAB node 605 relays the UL on the backhaul uplink from the IAB node 605 to the parent node 610 based on the PUSCH grant that the IAB node 605 received from the parent node in block 1125. For example, the IAB node 605 may transmit the UL on the backhaul uplink according to parameters set forth in the PUSCH grant.

FIG. 12 is a flow chart illustrating an exemplary process 1200 for interference handling in a network configured for full duplex in accordance with some aspects of the present disclosure. As described below, some or all illustrated features may be omitted in a particular implementation within the scope of the present disclosure, and some illustrated features may not be required for implementation of all embodiments. In some examples, the process 1200 may be carried out by the scheduled entity 800 illustrated in FIG. 8. In some examples, the process 1200 may be carried out by any suitable apparatus or means for carrying out the functions or algorithm described below.

At block 1202, a UE (e.g., the DL UE of FIG. 5) receives a channel state information (CSI) report configuration information message comprising an indication of a set of one or more candidate two-dimensional hypotheses, each corresponding to a DL parameter for a DL transmission to the UE and an UL parameter for an UL transmission from a second UE (also referred to as an aggressor UE) in full duplex. For example, a base station (e.g., the base station 505 of FIG. 5) may generate and send the CSI report configuration information message as described above with respect to blocks 902 and 904 of FIG. 9. The UE (e.g., the processor 804 via the CSI report communication circuit 840 and/or CSI report communication software 860) may then receive the CSI report configuration information message via the transceiver 810.

At block 1204, the UE measures a signal received from the second UE. For example, the signal from the second UE may be a reference signal, such as a CSI-RS, and the UE may measure or characterize the signal in terms of a strength or power level (e.g., in dBm). The UE (e.g., the processor 804 via the interference measurement circuit 842 and/or interference measurement software 862) may measure the signal received from the second UE.

At block 1206, the UE determines one or more two-dimensional hypotheses from the set of candidate two-dimensional hypotheses, based on the interference measurement. For example, the UE may determine the one or more preferred two-dimensional hypotheses as described above with respect to block 908 of FIG. 9. The UE (e.g., the processor 804 via the preferred hypothesis determination circuit 844 and/or preferred hypothesis determination software 864) may perform the determination.

At block 1208, the UE transmits a CSI report comprising an indication of the determined one or more two-dimensional hypotheses. For example, the UE may transmit the CSI report including the indication of the one or more preferred two-dimensional hypotheses as described above with respect to block 910 of FIG. 9. The UE (e.g., the processor 804 via the preferred hypothesis determination circuit 844 and/or preferred hypothesis determination software 864) may perform the determination. The UE may transmit the CSI report to the base station (e.g., the base station 505) that provided the set of candidate two-dimensional hypotheses to the UE.

In some examples, the UE receives a DL from the base station based on the CSI report. For example, as described above with respect to block 916, the UE may receive a DL from the base station based on a DL parameter that the base station determined based on the CSI report.

FIG. 13 is a flow chart illustrating an exemplary process 1300 for interference handling in a network configured for full duplex in accordance with some aspects of the present disclosure. As described below, some or all illustrated features may be omitted in a particular implementation within the scope of the present disclosure, and some illustrated features may not be required for implementation of all embodiments. In some examples, the process 1300 may be carried out by the scheduling entity 700 illustrated in FIG. 7. In some examples, the process 1300 may be carried out by any suitable apparatus or means for carrying out the functions or algorithm described below.

At block 1302, a base station (e.g., the base station 505 of FIG. 5) transmits a channel state information (CSI) report configuration message to a first (victim) user equipment (UE) (e.g., the DL UE of FIG. 5). The CSI report configuration message includes an indication of a set of one or more candidate two-dimensional hypotheses, each corresponding to a DL parameter for a DL transmission to the victim UE and an UL parameter for an UL transmission from a second UE (also referred to as an aggressor UE). For example, the base station may determine the set of one or more candidate two-dimensional hypotheses as described above with respect to block 902 of FIG. 9, and then transmit the CSI report as described above with respect to block 904 of FIG. 9. The base station (e.g., the processor 704 via the CSI report configuration and communication circuit 740 and/or CSI report configuration and communication software 760) may generate and transmit the CSI report configuration information message to the UE via the transceiver 710.

At block 1304, the base station receives a CSI report from the victim UE. The CSI report may include an indication of at least one two-dimensional hypothesis from the one or more candidate two-dimensional hypotheses. For example, the victim UE may determine the at least one preferred two-dimensional hypothesis and transmit the CSI report as described above with respect to blocks 906, 908, and 910 of FIG. 9. The base station (e.g., the processor 704 via the CSI report configuration and communication circuit 740 and/or CSI report configuration and communication software 760) may then receive the CSI report via the transceiver 710.

At block 1306, the base station transmits an uplink resource assignment for the second UE, and a DL parameter for a downlink transmission to the victim UE, based on the determined at least one two-dimensional hypothesis. For example, the base station may determine the UL parameter and DL parameter as described above with respect to block 912 of FIG. 9. Further, the base station may (1) transmit the uplink resource assignment associated with the UL parameter to the second UE as described with respect to block 914 and (2) transmit the DL to the victim UE based on the DL parameter as described above with respect to block 916. In some examples, the processor 704, via the transport format determination circuit 744 and/or transport format determination software 764, performs the determination in block 1306, and the scheduler circuit 742 and/or scheduler software 762 performs the transmission in block 1306.

FIG. 14 is a flow chart illustrating an exemplary process 1400 for interference handling in a network configured for full duplex in accordance with some aspects of the present disclosure. As described below, some or all illustrated features may be omitted in a particular implementation within the scope of the present disclosure, and some illustrated features may not be required for implementation of all embodiments. In some examples, the process 1400 may be carried out by the scheduled entity 800 illustrated in FIG. 8. In some examples, the process 1400 may be carried out by any suitable apparatus or means for carrying out the functions or algorithm described below.

At block 1402, a wireless communication victim node (e.g., the child node or DL UE 615 of FIG. 6A) receives a channel state information (CSI) report configuration message. The CSI report configuration message may include an indication of a set of one or more candidate hypotheses, each corresponding to a child link DL parameter for a child link between a relay node and the victim node. The CSI report configuration message may further include an indication of a backhaul downlink codebook configuration for a backhaul downlink between a parent node and the relay node.

For example, the victim node may receive the CSI report configuration message from a relay node (e.g., the IAB 605 of FIG. 6A) as described above with respect to block 1015 of FIG. 10. The relay node may generate and transmit to the relay node the CSI report configuration message as described above with respect to block 1005, 1010, and 1015 of FIG. 10. In some examples, the victim node (e.g., the processor 804 via the CSI report communication circuit 840 and/or CSI report communication software 860) may receive the CSI report configuration information message via the transceiver 810.

At block 1404, the victim node performs an interference measurement of a first signal received from the parent node and an interference measurement of a second signal received from the relay node. The victim node may perform the interference measurement as described above with respect to blocks 1025 of FIG. 10. For example, the first signal from the parent node may be a reference signal, such as a CSI-RS, and the second signal from the relay node may also be a reference signal, such as a CSI-RS. The resources over which the reference signals are transmitted may be indicated to the victim node by the CSI report configuration message received in block 1402. The victim node may receive the signals via the transceiver 810 and may measure the signals received from the parent node and the relay node via the interference measurement circuit 842 and/or interference measurement software 862).

At block 1406, the victim node determines one or more preferred beamforming parameters for the backhaul downlink and one or more preferred DL child link parameters for the child link based on the interference measurements and on the set of candidate hypotheses. For example, the victim node may determine the one or more preferred beamforming parameters and the one or more preferred DL child link parameters as described above with respect to block 1025 of FIG. 10. In some examples, the victim node may determine the one or more preferred beamforming parameters and the one or more preferred DL child link parameters via the preferred hypothesis determination circuit 844 and/or preferred hypothesis determination software 864.

At block 1408, the victim node transmits a CSI report comprising an indication of the one or more preferred beamforming parameters for the backhaul downlink and the one or more preferred DL child link parameters for the child link. For example, the victim node may transmit the CSI report as described above with respect to block 1030 of FIG. 10. In some examples, the victim node (e.g., the processor 804 via the CSI report communication circuit 840 and/or CSI report communication software 860) may transmit the CSI report via the transceiver 810.

In some examples, the victim node receives a DL from the relay node based on the CSI report. For example, as described above with respect to block 1045, the victim node may receive a DL from the relay node based on a DL child link parameter that the relay node determined based on the CSI report. The DL from the relay node may be a relayed DL from the parent node, where the parent node transmits the DL on the backhaul downlink to the relay node based on the CSI report. For example, the parent node may transmit the DL to the relay node based on the one or more preferred beamforming parameters of the CSI report.

FIG. 15 is a flow chart illustrating an exemplary process 1500 for interference handling in a network configured for full duplex in accordance with some aspects of the present disclosure. As described below, some or all illustrated features may be omitted in a particular implementation within the scope of the present disclosure, and some illustrated features may not be required for implementation of all embodiments. In some examples, the process 1500 may be carried out by the scheduling entity 700 illustrated in FIG. 7. In some examples, the process 1500 may be carried out by any suitable apparatus or means for carrying out the functions or algorithm described below.

At block 1502, a relay node (e.g., the IAB node 605 of FIG. 6A) receives a first channel state information (CSI) report configuration message from a parent node (e.g., the parent node 610 of FIG. 6A). The first CSI report configuration message may include an indication of a backhaul downlink codebook configuration for a backhaul downlink between the parent node and the relay node. For example, the relay node may receive the first CSI report configuration message as described with respect to block 1005 of FIG. 10. In some examples, the relay node (e.g., the processor 704 via the CSI report configuration and communication circuit 740 and/or CSI report configuration and communication software 760) may receive the first CSI report configuration message via the transceiver 710.

At block 1504, the relay node transmits a second channel state information (CSI) report configuration message, to a wireless communication victim node (e.g., the child node or DL UE 615). The second CSI report configuration message may include an indication of a set of one or more candidate hypotheses, each corresponding to a child link DL parameter for a child link between the relay node and the victim node. The second CSI report configuration message may further include an indication of a backhaul downlink codebook configuration for a backhaul downlink between the parent node and the relay node. For example, the relay node may transmit the second CSI report configuration message as described with respect to block 1015 of FIG. 10. In some examples, the relay node (e.g., the processor 704 via the CSI report configuration and communication circuit 740 and/or CSI report configuration and communication software 760) may transmit the second CSI report configuration message via the transceiver 710.

At block 1506, the relay node receives a first CSI report, from the victim UE, comprising an indication of one or more preferred beamforming parameters for the backhaul downlink and one or more preferred DL child link parameters for the child link. For example, the relay node may receive the first CSI report as described with respect to block 1030 of FIG. 10. In some examples, the relay node (e.g., the processor 704 via the CSI report configuration and communication circuit 740 and/or CSI report configuration and communication software 760) may receive the first CSI report via the transceiver 710.

At block 1508, the relay node transmits a second CSI report, to the parent node, based on the first CSI report. For example, the relay node may transmit the second CSI report as described with respect to block 1035 of FIG. 10, where the second CSI report is determined based on the first CSI report. In some examples, the relay node (e.g., the processor 704 via the CSI report configuration and communication circuit 740 and/or CSI report configuration and communication software 760) may transmit the second CSI report via the transceiver 710.

In some examples, the relay node receives a DL from the parent node based on the second CSI report. For example, as described above with respect to block 1040, the relay node may receive a DL from the parent node over the backhaul downlink that is transmitted by the parent node based on one or more preferred beamforming parameters of the second CSI report. The relay node may then relay the DL to the victim node, as described with respect to block 1045. For example, the relay node may transmit the DL to the victim node based on the one or more preferred DL child link parameters of the first CSI report.

FIG. 16 is a flow chart illustrating an exemplary process 1600 for interference handling in a network configured for full duplex in accordance with some aspects of the present disclosure. As described below, some or all illustrated features may be omitted in a particular implementation within the scope of the present disclosure, and some illustrated features may not be required for implementation of all embodiments. In some examples, the process 1600 may be carried out by the scheduling entity 700 illustrated in FIG. 7. In some examples, the process 1500 may be carried out by any suitable apparatus or means for carrying out the functions or algorithm described below.

At block 1602, a parent node (e.g., the parent node 610 of FIG. 6B) receives a sounding reference signal (SRS) measurement configuration message from a relay node (e.g., the IAB node 605 of FIG. 6B). The SRS measurement configuration message includes an indication of a set of one or more candidate hypotheses, each corresponding to a child link uplink (UL) parameter for a child link between the relay node and an aggressor node (e.g., the child node or UL UE 615 of FIG. 6B). For example, the relay node may transmit the SRS measurement configuration message as described above with respect to block 1110 of FIG. 11. The parent node (e.g., the processor 704 via the SRS configuration and communication circuit 746 and/or SRS configuration and communication software 766) may receive the SRS measurement configuration message via the transceiver 710.

At block 1604, the parent node performs an interference measurement of a first signal received from the aggressor node and an interference measurement of a second signal received from the relay node. For example, the parent node may perform the interference measurement as described above with respect to blocks 1120 of FIG. 11. In some examples, the first signal from the aggressor node may be a reference signal, such as a SRS, and the second signal from the relay node may also be a reference signal, such as a SRS. The resources over which the reference signals are transmitted may be indicated to the parent node by the SRS measurement configuration message received in block 1602. The parent node may receive the signals via the transceiver 710 and may measure the signals received from the aggressor node and the relay node via the interference measurement circuit 748 and/or interference measurement software 768.

At block 1606, the parent node determines a UL resource allocation to the relay node based on the interference measurements and on the set of candidate hypotheses. For example, the parent node may determine the UL resource allocation as described above with respect to blocks 1120 of FIG. 11. For example, the parent node may determine the UL resource allocation via the transport format determination circuitry 744 and/or the transport format determination software 764.

At block 1608, the parent node transmits the UL resource allocation to the relay node. For example, the parent node may transmit the UL resource allocation as described above with respect to block 1125 of FIG. 11. In some examples, the UL resource allocation may be a PUSCH grant. For example, the parent node may transmit the UL resource allocation via the scheduler circuit 742 and/or the scheduler software 762.

In some examples, the parent node receives a UL on the backhaul uplink from the relay node based on the UL resource allocation, as described with respect to block 1145. In some examples, the UL from the relay node may be a relayed UL from the aggressor node. The aggressor node may transmit the UL on the child link to the relay node based on further UL parameters determined and sent by the parent node to the relay node and relayed by the relay node to the aggressor node. For example, the further UL parameters may include a TPMI subset or SRI subset for use by the aggressor node in the UL transmission over the child link to the relay node.

FIG. 17 is a flow chart illustrating an exemplary process 1700 for interference handling in a network configured for full duplex in accordance with some aspects of the present disclosure. As described below, some or all illustrated features may be omitted in a particular implementation within the scope of the present disclosure, and some illustrated features may not be required for implementation of all embodiments. In some examples, the process 1700 may be carried out by the scheduling entity 700 illustrated in FIG. 7. In some examples, the process 1700 may be carried out by any suitable apparatus or means for carrying out the functions or algorithm described below.

At block 1704, a relay node (e.g., the IAB node 605 of FIG. 6B) transmits a sounding reference signal (SRS) measurement configuration message to a parent node (e.g., the parent node 610 of FIG. 6B). The SRS measurement configuration message may include an indication of a set of candidate hypotheses of uplink (UL) parameters for a UL child link between an aggressor node (e.g., the childe node or UL UE 615 of FIG. 6B) and the relay node. For example, the relay node may transmit the SRS measurement configuration message as described above with respect to block 1110 of FIG. 11. The relay node (e.g., the processor 704 via the SRS configuration and communication circuit 746 and/or SRS configuration and communication software 766) may transmit the SRS measurement configuration message via the transceiver 710.

At block 1706, the relay node transmits a reference signal. The reference signal may be an SRS that the relay node transmits in accordance with SRS resources indicated by the SRS measurement configuration message transmitted in block 1704, such as described with respect to block 1115 of FIG. 11. The relay node (e.g., the processor 704 via the SRS configuration and communication circuit 746 and/or SRS configuration and communication software 766) may transmit the reference signal via the transceiver 710.

At block 1708, the relay node receives a first UL resource allocation, from the parent node, corresponding to a backhaul uplink between the parent node and the relay node. For example, the parent node may transmit the UL resource allocation as described above with respect to block 1125 of FIG. 11. In some examples, the UL resource allocation may be a PUSCH grant. In some examples, the relay node may receive the UL resource allocation via the transceiver 710.

At block 1710, the relay node transmits a second UL resource allocation, to the aggressor node, based on the first UL resource allocation, the second UL resource allocation corresponding to a child link between the relay node and the aggressor node. For example, the relay node may transmit the UL resource allocation as described above with respect to block 1135 of FIG. 11. In some examples, the UL resource allocation may be a PUSCH grant. In some examples, the relay node may transmit the UL resource allocation via the scheduler circuit 742 and/or the scheduler software 762.

In some examples of the process 1700, the relay node also transmits a sounding reference signal (SRS) transmission configuration message to the aggressor. The SRS transmission configuration message may include an SRS resource configuration of a backhaul uplink between the parent node and the relay node. For example, the relay node may transmit the SRS transmission configuration message as described above with respect to block 1105 of FIG. 11. The relay node (e.g., the processor 704 via the SRS configuration and communication circuit 746 and/or SRS configuration and communication software 766) may transmit the SRS transmission configuration message via the transceiver 710. In some examples, this transmission of the SRS transmission configuration message may occur before the relay node transmits the reference signal in block 1706, and/or before the relay node receives the first UL resource allocation from the parent node in block 1708.

In some examples, the aggressor node may transmit a UL on a child link to the relay node based on the second UL resource allocation, as described with respect to block 1140. In some examples, the relay node may transmit the UL on the backhaul uplink to the parent node based on the first UL resource allocation, as described with respect to block 1145.

### Further Examples Having a Variety of Features

Example 1: A method, apparatus, and non-transitory computer-readable medium for interference handling are disclosed. In some examples, a user equipment (UE) includes a processor; a transceiver communicatively coupled to the processor; and a memory communicatively coupled to the processor. The processor and the memory are configured to receive, via the transceiver, a channel state information (CSI) report configuration information message including an indication of a set of one or more candidate two-dimensional hypotheses, each corresponding to a DL parameter for a DL transmission to the UE and an UL parameter for an UL transmission from a second UE. The processor and the memory are further configured to measure a signal received from the second UE, and to determine one or more two-dimensional hypotheses from the set of candidate two-dimensional hypotheses, based on the measurement of the signal. The processor and the memory are further configured to transmit, via the transceiver, a CSI report including an indication of the determined one or more two-dimensional hypotheses.
Example 2: A method, apparatus, and non-transitory computer-readable medium of Example 1, where the processor and the memory are further configured to determine one or more DL transmission parameters for the DL transmission to the UE, the one or more DL transmission parameters each corresponding to a two-dimensional hypothesis of the determined one or more two-dimensional hypotheses.
Example 3: A method, apparatus, and non-transitory computer-readable medium of Example 2, where the processor and the memory are further configured to determine a first DL transmission parameter of the one or more DL transmission parameters, the first DL transmission parameter corresponding to a first two-dimensional hypothesis of the set of one or more candidate two-dimensional hypotheses. Here, the determination of the first DL transmission parameter is based on a projected performance of the DL transmission. The processor and the memory are further configured to project the projected performance of the DL transmission based on an assumption that the second UE is configured with the UL parameter of the first two-dimensional hypothesis, and that the DL transmission is received using the same resources as the uplink transmission from the second UE.
Example 4: A method, apparatus, and non-transitory computer-readable medium of Example 2 or 3, where the one or more DL transmission parameters comprises a rank indicator (RI), a precoding matrix indicator (PMI), and a channel quality indicator (CQI).
Example 5: A method, apparatus, and non-transitory computer-readable medium of Example 2 or 4, where the processor and the memory are further configured to determine a first DL transmission parameter of the one or more DL transmission parameters, the first DL transmission parameter corresponding to a first two-dimensional hypothesis of the set of one or more candidate two-dimensional hypotheses. Here, the determination of the first DL transmission parameter is based on a projected CQI for the DL transmission. The processor and the memory are configured to project the projected CQI based on the DL parameter of the first two-dimensional hypothesis, and based on an assumption that the second UE is configured with the UL parameter of the first two-dimensional hypothesis, and that the DL transmission is received while the second UE transmits the UL transmission.
Example 6: A method, apparatus, and non-transitory computer-readable medium of any of Examples 2 to 5, where the processor and the memory are further configured to determine a first DL transmission parameter of the one or more DL transmission parameters, the first DL transmission parameter comprising a projected wideband signal-to-interference-and-noise ratio (SINR) or a projected wideband DL spectrum efficiency and the first DL transmission parameter corresponding to a first two-dimensional hypothesis of the set of one or more candidate two-dimensional hypotheses. The processor and the memory are further configured to project the projected SINR or DL spectrum efficiency based on the DL parameter of the first two-dimensional hypothesis, and based on an assumption that the second UE is configured with the UL parameter of the first two-dimensional hypothesis, and that the DL transmission is received while the second UE transmits the UL transmission.
Example 7: A method, apparatus, and non-transitory computer-readable medium of any of Examples 1 to 6, where the CSI report further comprises an indication of the one or more DL transmission parameters.
Example 8: A method, apparatus, and non-transitory computer-readable medium of any of Examples 1 to 6, where the processor and the memory are further configured to: receive a following CSI report configuration information message comprising an indication of a selected two-dimensional hypothesis; and transmit a following CSI report comprising an indication of a PMI, a CQI, and an RI corresponding to the selected two-dimensional hypothesis.
Example 9: A method, apparatus, and non-transitory computer-readable medium of any of Examples 1-8, where the processor and the memory are further configured to receive one or more reference signals (RS) from the second UE. Here, measuring the signal comprises characterizing the one or more RSs received from the second UE.
Example 10: A method, apparatus, and non-transitory computer-readable medium of any of Examples 1-9, where the UE is a victim UE, and wherein the processor and the memory are further configured to receive the DL transmission using the same resources as the second UE's UL transmission in a network configured for full duplex.
Example 11: A method, apparatus, and non-transitory computer-readable medium for interference handling are disclosed. In some examples, a scheduling entity includes a processor; a transceiver communicatively coupled to the processor; and a memory communicatively coupled to the processor. The processor and the memory are configured to transmit, via the transceiver, a channel state information (CSI) report configuration message to a first user equipment (UE), including an indication of one or more candidate two-dimensional hypotheses, each corresponding to a DL parameter for a DL transmission to the first UE and an UL parameter for an UL transmission from an second UE. The processor and the memory are further configured to receive, via the transceiver, a CSI report from the first UE, including an indication of at least one two-dimensional hypothesis from the one or more candidate two-dimensional hypotheses. The processor and the memory are also configured to transmit, based on the at least one two-dimensional hypothesis, an uplink resource assignment for the second UE and a DL parameter for a downlink transmission to the first UE.
Example 12: A method, apparatus, and non-transitory computer-readable medium of Example 11, wherein the DL transmission to the first UE corresponds to the same radio resources as the UL resource assignment for the second UE. Here, the processor and the memory are further configured to determine the DL parameter for the DL transmission to the first UE, and a UL parameter for the UL resource assignment for the second UE, based on a projected combined throughput when the second UE transmits an UL configured based on the UL parameter, and the first UE receives a DL configured based on the DL parameter.
Example 13: A method, apparatus, and non-transitory computer-readable medium of any of Examples 11 to 12, wherein the processor and the memory are configured to: transmit the downlink transmission to the first UE in accordance with the DL parameter.
Example 14: A method, apparatus, and non-transitory computer-readable medium of any of Examples 11 to 13, wherein the processor and the memory are configured to: transmit a following CSI report configuration message including the DL parameter and a UL parameter of the UL resource assignment; and receive a following CSI report including an indication of at least one subband CSI value determined based on the Dl parameter and the UL parameter.
Example 15: A method, apparatus, and non-transitory computer-readable medium for interference handling are disclosed. In some examples, a wireless communication victim node includes a processor; a transceiver communicatively coupled to the processor; and a memory communicatively coupled to the processor. The processor and the memory are configured to receive, via the transceiver, a channel state information (CSI) report configuration message. The CSI report configuration message includes an indication of a set of one or more candidate hypotheses, each corresponding to a child link DL parameter for a child link between a relay node and the victim node, and an indication of a backhaul downlink codebook configuration for a backhaul downlink between a parent node and the relay node. The processor and the memory are also configured to measure a first signal received from the parent node and a second signal received from the relay node. The processor and the memory are configured to determine one or more beamforming parameters for the backhaul downlink and one or more DL child link parameters for the child link based on the measurements of the first and second signals and on the set of candidate hypotheses. The processor and the memory are further configured to transmit, via the transceiver, a CSI report including an indication of the one or more beamforming parameters for the backhaul downlink and the one or more DL child link parameters for the child link.
Example 16: A method, apparatus, and non-transitory computer-readable medium of Example 15, wherein the processor and the memory are further configured to receive a downlink transmission from the relay node based on the CSI report.
Example 17: A method, apparatus, and non-transitory computer-readable medium of any of Examples 15 to 16, wherein downlink transmission from the relay node is a relayed downlink transmission that was transmitted on the backhaul downlink by the parent node to the relay node based on the CSI report.
Example 18: A method, apparatus, and non-transitory computer-readable medium of any of Examples 15 to 17, wherein the first signal is a first channel state information reference signal (CSI-RS) and the second signal is a second channel state information reference signal (CSI-RS).
Example 19: A method, apparatus, and non-transitory computer-readable medium of Example 18, wherein the CSI report configuration message further indicates resources over which the first CSI-RS and the second CSI-RS will be transmitted by the parent node and the relay node, respectively.
Example 20: A method, apparatus, and non-transitory computer-readable medium of any of Examples 15 to 19, wherein, to determine the one or more beamforming parameters and the one or more DL child link parameters, the processor and memory are further configured to: project downlink performance for each candidate hypothesis of the set of candidate hypotheses given the measurements of the first and second signals.
Example 21: A method, apparatus, and non-transitory computer-readable medium of any of Examples 15 to 20, wherein, to determine the one or more beamforming parameters and the one or more DL child link parameters, the processor and memory are further configured to: project downlink performance, given the measurements of the first and second signals, for a plurality of pairs of (i) a candidate beamforming parameter from a set of candidate beamforming parameters and (ii) a candidate hypothesis of the set of candidate hypotheses.
Example 22: A method, apparatus, and non-transitory computer-readable medium for interference handling are disclosed. In some examples, a wireless communication relay node includes a processor; a transceiver communicatively coupled to the processor; and a memory communicatively coupled to the processor. The processor and the memory are configured to receive, via the transceiver, a first channel state information (CSI) report configuration message, from a parent node, including an indication of a backhaul downlink codebook configuration for a backhaul downlink between the parent node and the relay node. The processor and the memory are also configured to transmit, via the transceiver, a second channel state information (CSI) report configuration message, to a wireless communication victim node (victim node). The CSI report configuration message includes an indication of a set of one or more candidate hypotheses, each corresponding to a child link downlink (DL) parameter for a child link between the relay node and the victim node, and an indication of a backhaul downlink codebook configuration for a backhaul downlink between the parent node and the relay node. The processor and the memory are further configured to receive, via the transceiver, a first CSI report, from the victim UE, including an indication of one or more beamforming parameters for the backhaul downlink and one or more DL child link parameters for the child link. The processor and the memory are further configured to transmit, via the transceiver, a second CSI report, to the parent node, based on the first CSI report.
Example 23: A method, apparatus, and non-transitory computer-readable medium of Example 22, wherein the processor and the memory are further configured to: receive, via the transceiver, a downlink transmission from the parent node based on the second CSI report.
Example 24: A method, apparatus, and non-transitory computer-readable medium of Example 23, wherein the processor and the memory are further configured to relay, via the transceiver, the downlink transmission to the victim node based on the first CSI report.
Example 25: A method, apparatus, and non-transitory computer-readable medium of any of Examples 22 to 24, wherein the second CSI report configuration message further indicates resources over which a first channel state information reference signal (CSI-RS) should be transmitted by the parent node and a second channel state information reference signal (CSI-RS) should be transmitted by the relay node.
Example 26: A method, apparatus, and non-transitory computer-readable medium of Example 25, wherein the processor and the memory are further configured to: transmit, via the transceiver, the second CSI-RS for measurement by the victim node.
Example 27: A method, apparatus, and non-transitory computer-readable medium of any of Examples 25 to 26, wherein the first CSI report is based on the first CSI-RS and the second CSI-RS.
Example 28: A method, apparatus, and non-transitory computer-readable medium for interference handling are disclosed. In some examples, a wireless communication parent node includes a processor; a transceiver communicatively coupled to the processor; and a memory communicatively coupled to the processor. The processor and the memory are configured to receive, via the transceiver, a sounding reference signal (SRS) measurement configuration message. The SRS measurement configuration message includes an indication of a set of one or more candidate hypotheses, each corresponding to a child link uplink (UL) parameter for an UL child link between a relay node and an aggressor node. The processor and the memory are also configured to measure a first signal received from the aggressor node and a second signal received from the relay node; and to determine a UL resource allocation to the relay node based on the measurements of the first and second signals and on the set of candidate hypotheses. The processor and the memory are further configured to transmit, via the transceiver, the UL resource allocation to the relay node.
Example 29: A method, apparatus, and non-transitory computer-readable medium of Example 28, wherein the processor and the memory are further configured to: receives an uplink transmission from the relay node based on the UL resource allocation.
Example 30: A method, apparatus, and non-transitory computer-readable medium of Example 29, wherein the uplink transmission from the relay node is a relayed uplink transmission that was transmitted on the UL child link by the aggressor node to the relay node.
Example 31: A method, apparatus, and non-transitory computer-readable medium of any of Examples 28 to 30, wherein the first signal is a first sounding reference signal (SRS) and the second signal is a second sounding reference signal (SRS).
Example 32: A method, apparatus, and non-transitory computer-readable medium of any of Examples 28 to 31, wherein the SRS measurement configuration message further indicates resources over which the first SRS will be transmitted by the aggressor node.
Example 33: A method, apparatus, and non-transitory computer-readable medium of any of Examples 28 to 32, wherein, to determine the UL resource allocation, the processor and memory are further configured to: project uplink performance for each candidate hypothesis of the set of candidate hypotheses given the measurements of the first and second signals.
Example 34: A method, apparatus, and non-transitory computer-readable medium of any of Examples 28 to 33, wherein, to determine the UL resource allocation, the processor and memory are further configured to: project uplink performance, given the measurements of the first and second signals, for a plurality of pairs of (i) a candidate transmit precoding matrix index (TPMI) or SRS resource indicator (SRI) subset from a set of candidate TPMI or SRI subsets and (ii) a candidate hypothesis of the set of candidate hypotheses.
Example 35: A method, apparatus, and non-transitory computer-readable medium of any of Examples 28 to 34, wherein the processor and memory are further configured to: determine a precoding matrix index (TPMI) or SRS resource indicator (SRI) subset for the UL child link based on the measurements of the first and second signals; and transmit, via the transceiver, the TPMI or SRI subset to the relay node.
Example 36: A method, apparatus, and non-transitory computer-readable medium for interference handling are disclosed. In some examples, a wireless communication relay node includes a processor; a transceiver communicatively coupled to the processor; and a memory communicatively coupled to the processor. The processor and the memory are configured to transmit, via the transceiver, a sounding reference signal (SRS) measurement configuration message, to a parent node. The SRS measurement configuration message includes an indication of a set of candidate hypotheses of uplink (UL) parameters for a UL child link between an aggressor node and the relay node. The processor and the memory are configured to transmit, via the transceiver, a first reference signal; and to receive, via the transceiver, a first UL resource allocation, from the parent node, corresponding to a backhaul uplink between the parent node and the relay node. The processor and the memory are further configured to transmit, via the transceiver, a second UL resource allocation, to the aggressor node, based on the first UL resource allocation, the second UL resource allocation corresponding to the UL child link between the relay node and the aggressor node.
Example 37: A method, apparatus, and non-transitory computer-readable medium of Example 36, wherein the processor and the memory are further configured to: receive, via the transceiver, an uplink transmission from the aggressor node based on the second UL resource allocation.
Example 38: A method, apparatus, and non-transitory computer-readable medium of Example 37 wherein the processor and the memory are further configured to: relay, via the transceiver, the uplink transmission to the parent node based on the first UL resource allocation.
Example 39: A method, apparatus, and non-transitory computer-readable medium of any of Examples 36 to 38, wherein the processor and the memory are further configured to: transmit, via the transceiver, a sounding reference signal (SRS) transmission configuration message, to the aggressor node, comprising an SRS resource configuration of the backhaul uplink between the parent node and the relay node, wherein the SRS transmission configuration message further indicates resources over which a second reference signal should be transmitted by the aggressor node.
Example 40: A method, apparatus, and non-transitory computer-readable medium of any of Examples 36 to 39, wherein the SRS measurement configuration message further indicates resources over which the aggressor node should transmit a second reference signal.
Example 41: A method, apparatus, and non-transitory computer-readable medium of any of Examples 36 to 40, wherein the first UL resource allocation is based on the first reference signal, the second reference signal, and the set of candidate hypotheses of uplink (UL) parameters for a UL child link between the aggressor node and the relay node.
Example 42: A method, apparatus, and non-transitory computer-readable medium of any of Examples 36 to 41, wherein the processor and memory are further configured to: receive, via the transceiver, a precoding matrix index (TPMI) or SRS resource indicator (SRI) subset for the UL child link from the parent node; and transmit, via the transceiver, the TPMI or SRI subset to the aggressor node.

This disclosure presents several aspects of a wireless communication network with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the term “coupled” to refer to a direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-17 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-17 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE) configured for wireless communication, comprising:
a processor;
a transceiver communicatively coupled to the processor; and
a memory communicatively coupled to the processor,
wherein the processor and the memory are configured to:
receive, via the transceiver, a channel state information (CSI) report configuration information message comprising an indication of a set of one or more candidate two-dimensional hypotheses, each candidate two-dimensional hypothesis corresponding to a DL parameter for a DL transmission to the UE and an UL parameter for an UL transmission from a second UE;
measure a signal received from the second UE;
determine one or more two-dimensional hypotheses from the set of one or more candidate two-dimensional hypotheses, based on the measurement of the signal; and
transmit, via the transceiver, a CSI report comprising an indication of the determined one or more two-dimensional hypotheses.

2. The UE of claim 1, wherein the processor and the memory are further configured to:
determine one or more DL transmission parameters for the DL transmission to the UE, the one or more DL transmission parameters each corresponding to a two-dimensional hypothesis of the determined one or more two-dimensional hypotheses.

3. The UE of claim 2, wherein the processor and the memory are further configured to determine a first DL transmission parameter of the one or more DL transmission parameters, the first DL transmission parameter corresponding to a first two-dimensional hypothesis of the set of one or more candidate two-dimensional hypotheses,
wherein the determination of the first DL transmission parameter is based on a projected performance of the DL transmission,
wherein the processor and the memory are further configured to project the projected performance of the DL transmission based on an assumption that the second UE is configured with the UL parameter of the first two-dimensional hypothesis, and that the DL transmission is received using the same resources as the UL transmission from the second UE.

4. The UE of claim 2, wherein the one or more DL transmission parameters comprises a rank indicator (RI), a precoding matrix indicator (PMI), and a channel quality indicator (CQI).

5. The UE of claim 2,
wherein the processor and the memory are further configured to determine a first DL transmission parameter of the one or more DL transmission parameters, the first DL transmission parameter corresponding to a first two-dimensional hypothesis of the set of one or more candidate two-dimensional hypotheses,
wherein the determination of the first DL transmission parameter is based on a projected CQI for the DL transmission,
wherein the processor and the memory are configured to project the projected CQI
based on the DL parameter of the first two-dimensional hypothesis, and
based on an assumption that the second UE is configured with the UL parameter of the first two-dimensional hypothesis, and that the DL transmission is received while the second UE transmits the UL transmission.

6. The UE of claim 2,
wherein the processor and the memory are further configured to determine a first DL transmission parameter of the one or more DL transmission parameters, the first DL transmission parameter comprising a projected wideband signal-to-interference-and-noise ratio (SINR) or a projected wideband DL spectrum efficiency and the first DL transmission parameter corresponding to a first two-dimensional hypothesis of the set of one or more candidate two-dimensional hypotheses,
wherein the processor and the memory are configured to project the projected SINR or DL spectrum efficiency
based on the DL parameter of the first two-dimensional hypothesis, and
based on an assumption that the second UE is configured with the UL parameter of the first two-dimensional hypothesis, and that the DL transmission is received while the second UE transmits the UL transmission.

7. The UE of claim 2, wherein the CSI report further comprises an indication of the one or more DL transmission parameters.

8. The UE of claim 1, wherein the processor and the memory are further configured to:
receive a following CSI report configuration information message comprising an indication of a selected two-dimensional hypothesis; and
transmit a following CSI report comprising an indication of a rank indicator (RI), a precoding matrix indicator (PMI), and a channel quality indicator (CQI) corresponding to the selected two-dimensional hypothesis.

9. The UE of claim 1, wherein the processor and the memory are further configured to receive one or more reference signals (RS) from the second UE,
wherein measuring the signal comprises characterizing the one or more RSs received from the second UE.

10. The UE of claim 1, wherein the UE is a victim UE, and wherein the processor and the memory are further configured to receive the DL transmission using the same resources as the second UE's UL transmission in a network configured for full duplex.

11. A scheduling entity configured for wireless communication, comprising:
a processor;
a transceiver communicatively coupled to the processor; and
a memory communicatively coupled to the processor,
wherein the processor and the memory are configured to:
transmit, via the transceiver, a channel state information (CSI) report configuration message to a first user equipment (UE), comprising an indication of one or more candidate two-dimensional hypotheses, each corresponding to a DL parameter for a DL transmission to the first UE and an UL parameter for an UL transmission from a second UE;
receive, via the transceiver, a CSI report from the first UE, comprising an indication of at least one two-dimensional hypothesis from the one or more candidate two-dimensional hypotheses; and
transmit, based on the at least one two-dimensional hypothesis, an uplink (UL) resource assignment for the second UE and a DL parameter for a downlink transmission to the first UE.

12. The scheduling entity of claim 11, wherein the DL transmission to the first UE corresponds to the same radio resources as the UL resource assignment for the second UE,
wherein the processor and the memory are further configured to determine the DL parameter for the DL transmission to the first UE, and a UL parameter for the UL resource assignment for the second UE, based on a projected combined throughput when the second UE transmits an UL configured based on the UL parameter, and the first UE receives a DL configured based on the DL parameter.

13. The scheduling entity of claim 11, wherein the processor and the memory are configured to:
transmit the downlink transmission to the first UE in accordance with the DL parameter.

14. The scheduling entity of claim 11, wherein the processor and the memory are configured to:
transmit a following CSI report configuration message including the DL parameter and a UL parameter of the UL resource assignment; and
receive a following CSI report including an indication of at least one subband CSI value determined based on the Dl parameter and the UL parameter.

15. A user equipment (UE) configured for wireless communication, comprising:
means for receiving a channel state information (CSI) report configuration information message comprising an indication of a set of one or more candidate two-dimensional hypotheses, each candidate two-dimensional hypotheses corresponding to a DL parameter for a DL transmission to the UE and an UL parameter for an UL transmission from a second UE;
means for measuring a signal received from the second UE;
means for determining one or more two-dimensional hypotheses from the set of one or more candidate two-dimensional hypotheses, based on the measurement of the signal; and
means for transmitting a CSI report comprising an indication of the determined one or more two-dimensional hypotheses.

16. The UE of claim 15, further comprising:
means for determining one or more DL transmission parameters for the DL transmission to the UE, the one or more DL transmission parameters each corresponding to a two-dimensional hypothesis of the determined one or more two-dimensional hypotheses.

17. The UE of claim 16, further comprising:
means for determining a first DL transmission parameter of the one or more DL transmission parameters, the first DL transmission parameter corresponding to a first two-dimensional hypothesis of the set of one or more candidate two-dimensional hypotheses,
wherein the determination of the first DL transmission parameter is based on a projected performance of the DL transmission; and
means for projecting the projected performance of the DL transmission based on an assumption that the second UE is configured with the UL parameter of the first two-dimensional hypothesis, and that the DL transmission is received using the same resources as the UL transmission from the second UE.

18. The UE of claim 16, further comprising:
means for determining a first DL transmission parameter of the one or more DL transmission parameters, the first DL transmission parameter corresponding to a first two-dimensional hypothesis of the set of one or more candidate two-dimensional hypotheses,
wherein the determination of the first DL transmission parameter is based on a projected CQI for the DL transmission; and
means for projecting the projected CQI
based on the DL parameter of the first two-dimensional hypothesis, and
based on an assumption that the second UE is configured with the UL parameter of the first two-dimensional hypothesis, and that the DL transmission is received while the second UE transmits the UL transmission.

19. The UE of claim 16, further comprising:
means for determining a first DL transmission parameter of the one or more DL transmission parameters, the first DL transmission parameter comprising a projected wideband signal-to-interference-and-noise ratio (SINR) or a projected wideband DL spectrum efficiency and the first DL transmission parameter corresponding to a first two-dimensional hypothesis of the set of one or more candidate two-dimensional hypotheses,
means for projecting the projected SINR or DL spectrum efficiency
based on the DL parameter of the first two-dimensional hypothesis, and
based on an assumption that the second UE is configured with the UL parameter of the first two-dimensional hypothesis, and that the DL transmission is received while the second UE transmits the UL transmission.

20. The UE of claim 15, further comprising:
means for receiving a following CSI report configuration information message comprising an indication of a selected two-dimensional hypothesis; and
means for transmitting a following CSI report comprising an indication of a rank indicator (RI), a precoding matrix indicator (PMI), and a channel quality indicator (CQI) corresponding to the selected two-dimensional hypothesis.

21. The UE of claim 15, further comprising:
means for receiving one or more reference signals (RS) from the second UE,
wherein measuring the signal comprises characterizing the one or more RSs received from the second UE.

22. The UE of claim 15, further comprising:
means for receiving the DL transmission using the same resources as the second UE's UL transmission in a network configured for full duplex, and
wherein the UE is a victim UE.

23. A method of wireless communication at a user equipment (UE), the method comprising:
receiving a channel state information (CSI) report configuration information message comprising an indication of a set of one or more candidate two-dimensional hypotheses, each candidate two-dimensional hypotheses corresponding to a DL parameter for a DL transmission to the UE and an UL parameter for an UL transmission from a second UE;
measuring a signal received from the second UE;
determining one or more two-dimensional hypotheses from the set of one or more candidate two-dimensional hypotheses, based on the measurement of the signal; and
transmitting a CSI report comprising an indication of the determined one or more two-dimensional hypotheses.

24. The method of claim 23, further comprising:
determining one or more DL transmission parameters for the DL transmission to the UE, the one or more DL transmission parameters each corresponding to a two-dimensional hypothesis of the determined one or more two-dimensional hypotheses.

25. The method of claim 24, further comprising:
determining a first DL transmission parameter of the one or more DL transmission parameters, the first DL transmission parameter corresponding to a first two-dimensional hypothesis of the set of one or more candidate two-dimensional hypotheses,
wherein the determining of the first DL transmission parameter is based on a projected performance of the DL transmission; and
projecting the projected performance of the DL transmission based on an assumption that the second UE is configured with the UL parameter of the first two-dimensional hypothesis, and that the DL transmission is received using the same resources as the UL transmission from the second UE.

26. The method of claim 24, further comprising:
determining a first DL transmission parameter of the one or more DL transmission parameters, the first DL transmission parameter corresponding to a first two-dimensional hypothesis of the set of one or more candidate two-dimensional hypotheses,
wherein the determining of the first DL transmission parameter is based on a projected CQI for the DL transmission; and
projecting the projected CQI
based on the DL parameter of the first two-dimensional hypothesis, and
based on an assumption that the second UE is configured with the UL parameter of the first two-dimensional hypothesis, and that the DL transmission is received while the second UE transmits the UL transmission.

27. The method of claim 24, further comprising:
determining a first DL transmission parameter of the one or more DL transmission parameters, the first DL transmission parameter comprising a projected wideband signal-to-interference-and-noise ratio (SINR) or a projected wideband DL spectrum efficiency and the first DL transmission parameter corresponding to a first two-dimensional hypothesis of the set of one or more candidate two-dimensional hypotheses; and
projecting the projected SINR or DL spectrum efficiency
based on the DL parameter of the first two-dimensional hypothesis, and
based on an assumption that the second UE is configured with the UL parameter of the first two-dimensional hypothesis, and that the DL transmission is received while the second UE transmits the UL transmission.

28. The method of claim 23, further comprising:
receiving a following CSI report configuration information message comprising an indication of a selected two-dimensional hypothesis; and
transmitting a following CSI report comprising an indication of a rank indicator (RI), a precoding matrix indicator (PMI), and a channel quality indicator (CQI) corresponding to the selected two-dimensional hypothesis.

29. The method of claim 23, further comprising:
receiving one or more reference signals (RS) from the second UE,
wherein measuring the signal comprises characterizing the one or more RSs received from the second UE.

30. The method of claim 23, wherein the UE is a victim UE, the method further comprising:
receiving the DL transmission using the same resources as the second UE's UL transmission in a network configured for full duplex.
